(19) United States
(12) Patent Application Publication
(10) Pub. No.: US 2004/0093266 A1
(43) Pub. Date: May 13, 2004

(54) Method of mutually enhancing retail sales and user traffic on a web site

(76) Inventor: Doug Carl Dohring, Glendale, CA (US)

Correspondence Address: Gibson, Dunn & Crutcher LLP, Suite 4100, 1801 California Street, Denver, CO, 80202, US

(21) Appl. No.: 10/292,895

(22) Filed: Nov. 12, 2002

(51) Int. Cl. G06F 17/60

(52) U.S. Cl. 705/14

(57) ABSTRACT

A method of mutually enhancing retail sales and user traffic on a web site involves offering an item code to a customer at a retail store, a place of business, or other promotional site in one of several different ways. Instructions are provided with the item code directing the customer to visit a web site, the instructions including the URL of the web site. The customer accesses the web site utilizing the URL address. The customer enters the item code where provided for on the web page and submits the item code. A server computer receives the item code, processes the item code, and returns to the customer's computer a web page for display indicating the virtual item that the customer has acquired through the item code. The customer may now interact within the environment provided for by the web site with the virtual item acquired.

### FIELD OF THE INVENTION

This invention relates to merchandising and web sites, and more particularly, to a method of mutually enhancing retail sales and user traffic on a web site.

### BRIEF DESCRIPTION OF THE DRAWINGS

FIG. 1 shows a front side of a promotional card distributed to a customer at a retail store in an embodiment of the present invention.

FIG. 2 shows a back side of the promotional card of FIG. 1 distributed to a customer at a retail store in an embodiment of the present invention.

FIGS. 3-6 show representations of exemplary screen shots of web pages delivered by a server computer that may be displayed through a web browser on a display device of a customer computer in an embodiment of the present invention.

FIG. 7 shows an outer front side of a product package containing a product made available to a customer at a retail store in an embodiment of the present invention.

FIG. 8 shows an outer back side of the product package of FIG. 7 made available to a customer at a retail store in an embodiment of the present invention.

FIG. 9 shows an interior side of the product package of FIG. 7 or FIG. 8.

FIGS. 10-11 show representations of exemplary screen shots of web pages delivered by a server computer that may be displayed through a web browser on a display device of a customer computer in an embodiment of the present invention.

FIGS. 12-42 show representations of exemplary screen shots of web pages delivered by a server computer that may be displayed through a web browser on a display device of a customer computer in an embodiment of the present invention.

FIG. 43 shows a flow diagram of an embodiment of the method of the present invention.

FIGS. 44 and 45 show an example of the item code, instructions, and URL being on the good itself.

FIGS. 46 and 47 show an example of the item code, instructions, and URL being on the packaging material.

### DETAILED DESCRIPTION OF THE INVENTION

Many goods and services traditionally sold in retail establishments are now also sold on-line through web sites on the Internet. An Internet presence helps promote the sale of goods and services both on-line and in retail stores. Advertising and promotion of the goods and services, in addition to traditional advertising avenues (e.g., television, radio, newspapers, magazines, billboards, etc.) is now also done through web sites on the Internet. Many web sites are funded by, or derive revenue streams from, banner ads, click through ads (a link to the advertiser's own web site), and the like displayed on the web site. The more traffic a web site experiences, the larger the potential revenue from ad placement on the web site. The method of the present invention stimulates in-store purchases of goods and services or in-store traffic, as well as enhances traffic on a web site affiliated with, or which advertises, the goods or services.

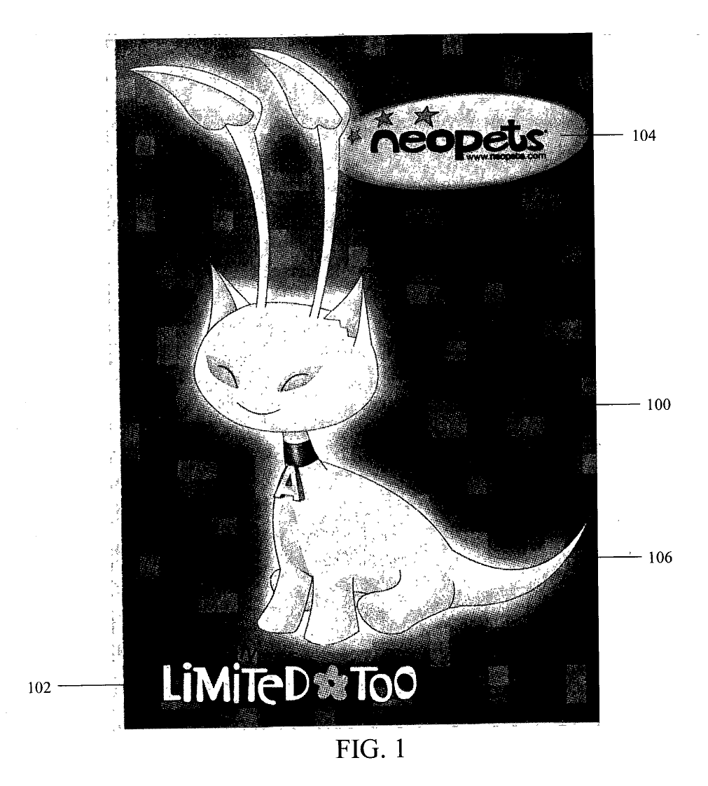

Referring now to the Figures, in which like reference numerals refer to like components thereof, FIG. 1 shows a front side of a promotional card distributed to a customer at a retail store in an embodiment of the present invention. Referring now to FIG. 1, Card Front 100 may be a promotional card given out to the first one-hundred customers to enter a retail store on a given day where no purchase of goods or services is necessary. Or, Card Front 100 may be given out to each customer who purchases goods or services, such as getting a haircut on a particular day or getting a haircut during a particular period of time during the day at a particular hair salon. Card Front 100 may have Store Name 102, which identifies the retail store associated with the promotion, and a graphic for Web Site 104, which identifies the web site associated with the promotion. Card Front 100 may also have Product Graphic Image 106 of the good or service associated with the promotion, such as the plush toy depicted by Product Graphic Image 106. Card Front 100 may have other printed instructions and graphics to enhance the appearance of the card and to provide the customer with other useful information.

The retail store and the web site in one aspect of the invention may be owned by the same corporate entity or individual, where the web site is an extension of the retail store and vice versa. In another aspect of the invention, the retail store and the web site are owned by different corporate entities or individuals who are partnering together to promote each other's interests. In yet another embodiment of the invention, the promotion may be between the web site and the manufacturer of a product that is sold through various retail outlets. In the later case, the web site and the manufacturer are partnering together for the promotion apart from the various retail outlets that happen to carry the good or service for sale.

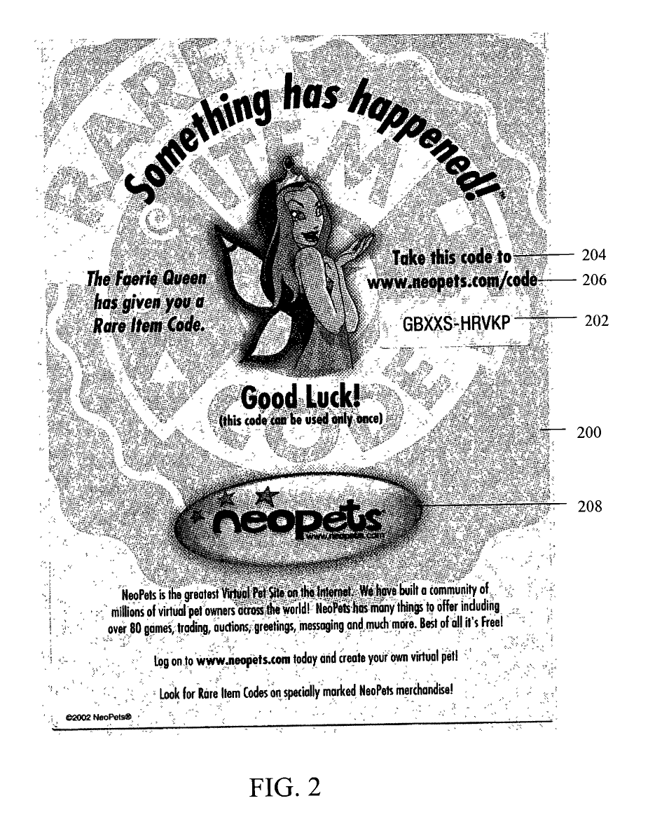

FIG. 2 shows a back side of the promotional card of FIG. 1 distributed to a customer at a retail store in an embodiment of the present invention. Referring now to FIG. 2, Card Back 200 has a code, such as Item Code 202. Item Code 202 may be a series of numbers, letters, symbols, etc., or any combination of the above. Instructions 204 instruct the customer to use the Item Code 202 at a Web Site Sponsor 208 whose address is indicated by URL 206. Item Code 202 may be redeemed for a virtual item by going to URL 206. A virtual item is an item or object that exists only within the virtual world of Web Site 104. Card Back 200 may have other printed instructions and graphics to enhance the appearance of the card and to provide the customer with other useful information. In another embodiment of the invention, only one side of the promotional card contains the information shown on Card Front 100 and Card Back 200.

In other embodiments of the invention, some or all of the components of Card Front 100 and Card Back 200 may be associated with an item for sale. For example, some or all of the above information may be pre-printed on the inside cover of a note pad which may be shrink-wrapped to protect the Item Code 202 from being misappropriated by someone other than the purchaser. In order to obtain the Item Code 202, a customer must purchase the item because the Item Code 202 will not be visible and the shrink-wrap must be removed in order to view Item Code 202. In another embodiment, Item Code 202, Instructions 204, and URL 206, may be found on a sealed tag or sealed card attached to a plush toy, jewelry, or some other good, such that the good must be purchased in order for the customer to open the seal and appropriate Item Code 202. In another embodiment of the invention, Item Code 202, Instructions 204, and URL 206, are contained on the good or in packaging material of the good for sale. Crack-and-peel labels, as well as scratch-off cards may also be used to conceal Item Code 202. One skilled in the art will recognize that there are numerous ways utilizing various materials to associate some or all of the components of Card Front 100 and Card Back 200 with a good or service for sale to discourage tampering prior to the purchase of the good or service.

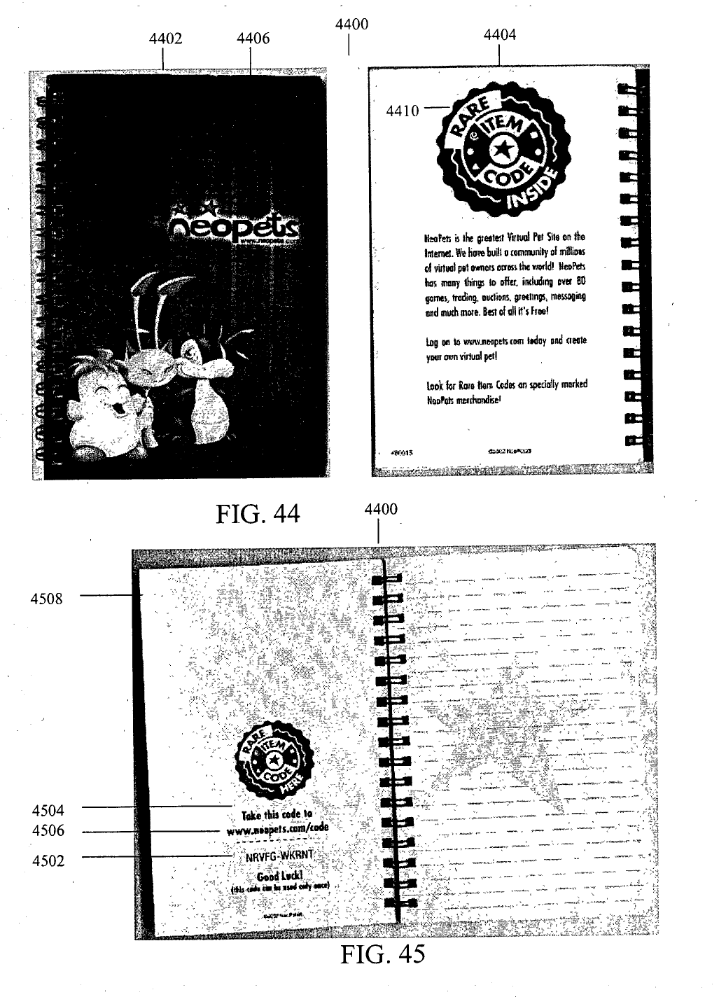

An example of the item code, instructions, and URL being on the good itself is shown in FIGS. 44 and 45. FIG. 44 shows Front Cover 4402 and Back Cover 4404 of Spiral Notebook 4400, which in this case is a product of the web site sponsor. Spiral Notebook 4400 is sold in various retail outlets in shrink-wrap form such that Front Cover 4402 and Back Cover 4404 are visible through the shrink-wrap, but not the inside covers or any interior pages. Web Site 4406 and Graphic Image 4408 help identify the source of Spiral Notebook 4400. Item Code Inside Graphic 4410 informs the customer that an item code may be found inside Spiral Notebook 4400. In FIG. 45, after purchase by a customer, Inside Front Cover 4508 is shown after the shrink-wrap has been removed. Item Code 4502, Instructions 4504, and URL 4506, are printed on Inside Front Cover 4508.

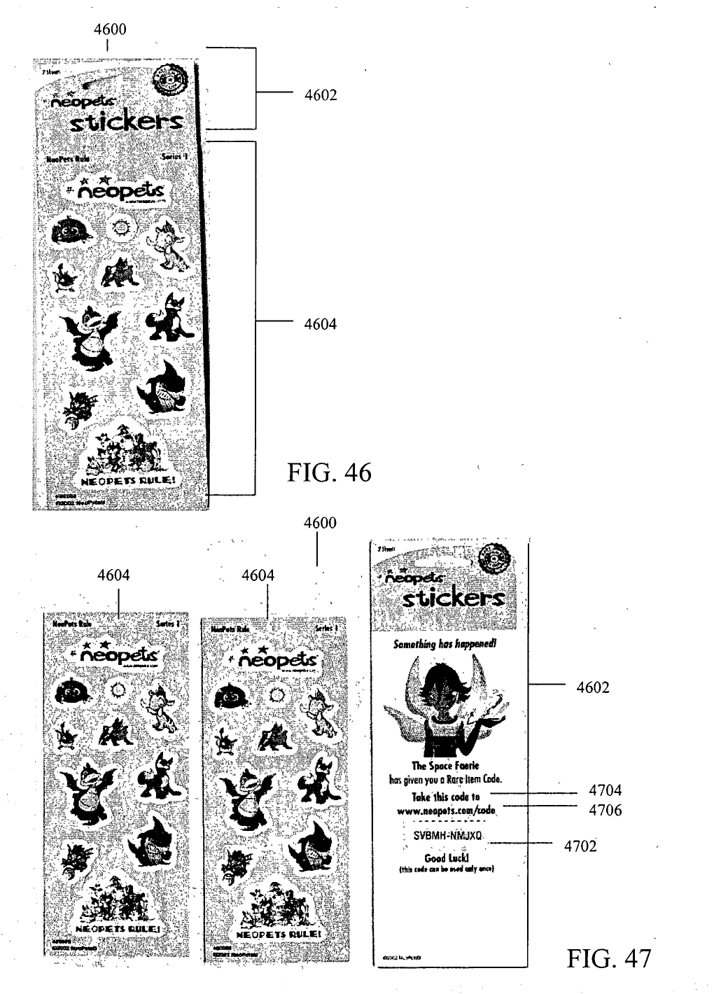

An example of the item code, instructions, and URL being on the packaging material is shown in FIGS. 46 and 47. Sticker Packet 4600 is shown shrink-wrapped, which in this case is also a product of the web site sponsor. Packaging Card 4602 is only partly visible in the shrink-wrapped state, but fully visible once a customer has purchased Sticker Packet 4600 and has removed the shrink-wrap. Two Sticker Sheets 4604, having an assortment of various character stickers, are packaged with Packaging Card 4602. Item Code 4702, Instructions 4704, and URL 4706, are printed on Packaging Card 4602.

In another embodiment of the invention, where the item code is hidden from view prior to purchasing the good or service, there may or may not be an item code found on the good or on the packaging material. In other words, purchasing a good or service does not guarantee that an item code will be obtained, and thus, acquiring a virtual item is not guaranteed. This may add to the element of risk associated with a particular promotion.

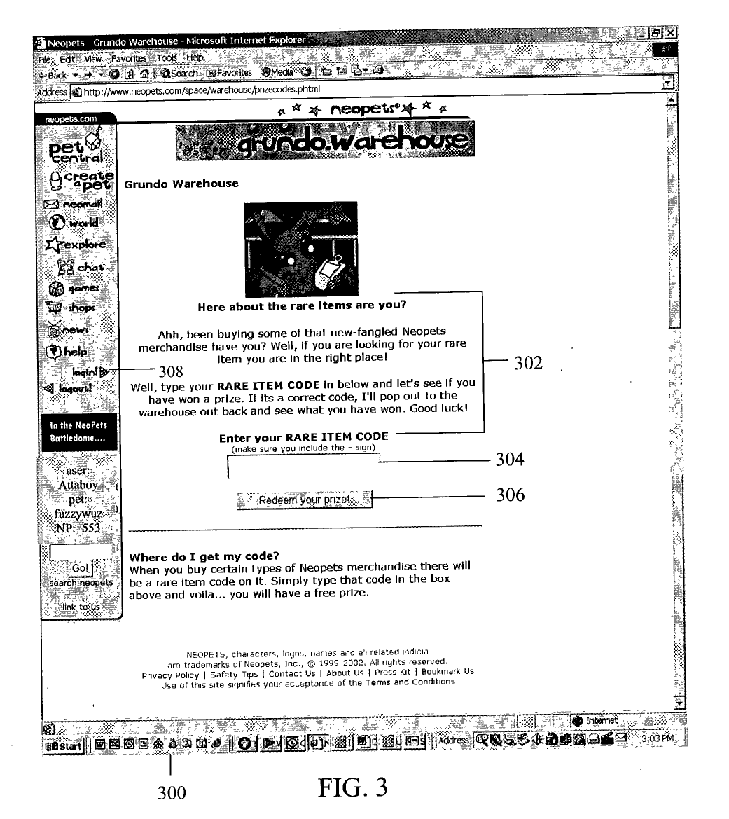

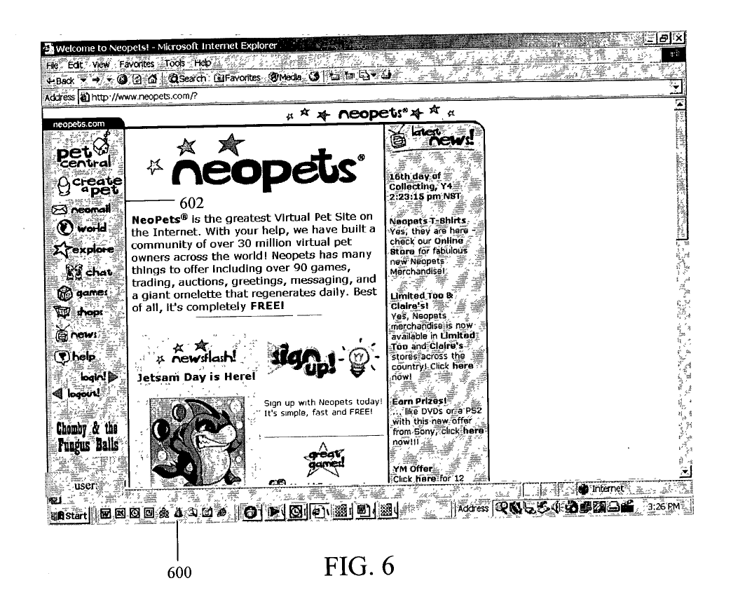

FIGS. 3-6 show representations of exemplary screen shots of web pages delivered by a server computer that may be displayed through a web browser on a display device of a customer computer in an embodiment of the present invention. Referring now to FIG. 3, the customer that has received the promotional card with Card Front 100 and Card Back 200 having Item Code 202, Instructions 204, and URL 206, or has purchased a good or service from the retail store containing Item Code 202, Instructions 204, and URL 206, has entered URL 206 through a web browser displayed on a monitor of the customer's computer. Item Code Web Page 300 is returned to the customer's computer and displayed on the monitor by a server computer associated with URL 206 and Web Site 104. Registered users of Web Site 104 may have already logged in to Web Site 104 prior to this point from the Home Web Page 600 (FIG. 6). If not, the user can log in from Item Code Web Page 300 by clicking on Login Button 308 and following the login procedure for Web Site 104, such procedures being well known in the art. Instructions 302 provide the customer with information about the virtual item and how to enter Item Code 202. Entry Box 304 is provided for the customer to enter Item Code 202.

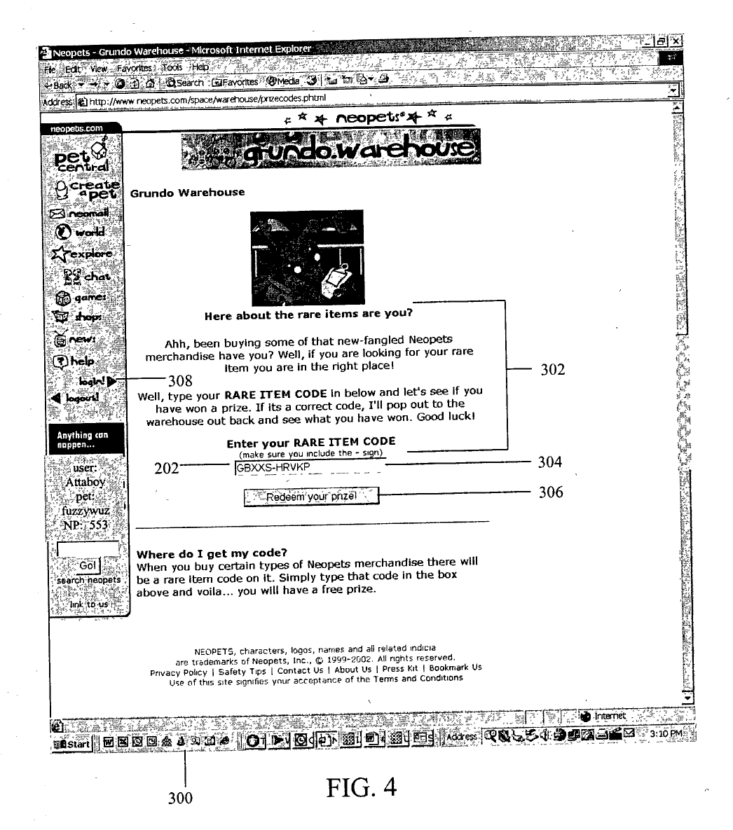

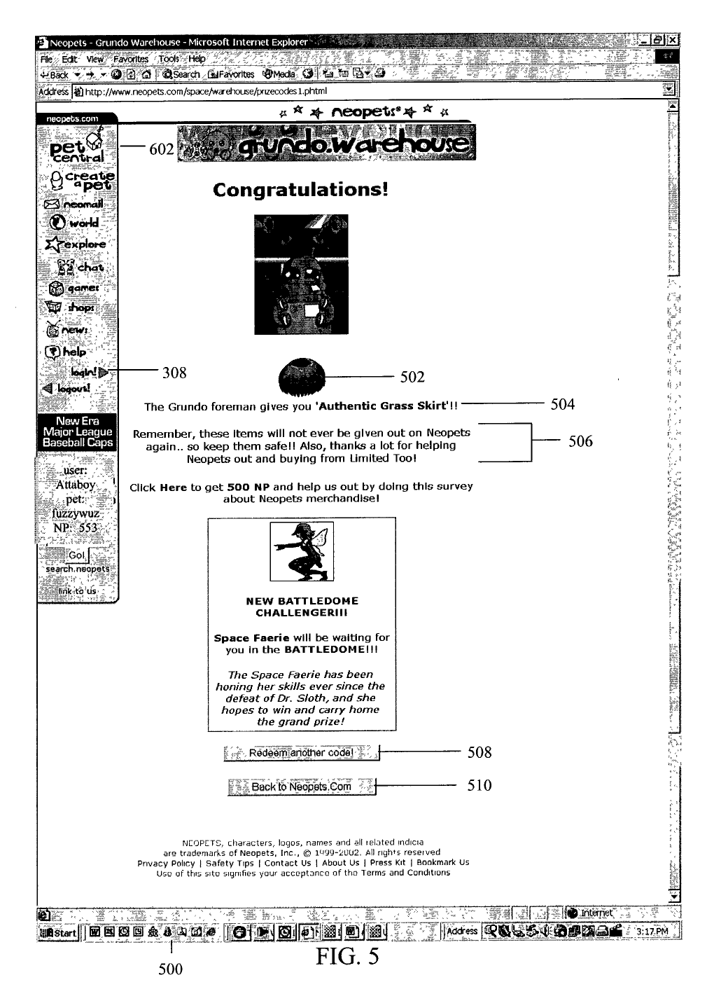

Referring now to FIG. 4, the customer has typed Item Code 202 printed on Card Front 100 into Entry Box 304. When the customer clicks on Button Bar 306, the server computer returns Congratulations Web Page 500 (FIG. 5) to the customer's computer for display on the customer's monitor.

Referring now to FIG. 5, Virtual Item 502 is displayed as a graphic image. Name Text 504 gives the name of Virtual Item 502. Additional Text 506 provides more information regarding Virtual Item 502. In this context, Virtual Item 502 may be a rare virtual item on the web site, making it more valuable and desirable to obtain by the customer. In one embodiment of the invention, the only way to obtain Virtual Item 502 is through securing Item Code 202 from a promotion and not from normal use of Web Site 104. Thus, the rarity of Virtual Item 502, or its unavailability through normal use of Web Site 104, motivates the customer to obtain the Item Code 202 from the merchant offering the promotion by buying the goods or service associated with the promotion, or visiting the retail store where the promotional card is made available. Once the customer has obtained the promotional card having Item Code 202 from the merchant, the customer is motivated to go to the web site to redeem Item Code 202 for Virtual Item 502.

As an example, for a particular promotion, there may be ten types of rare virtual items that will be made available to the public. Of those ten types, there may be a different number of virtual items of a particular type to be made available. For example, 6,000 virtual items of type one may be made available, 4,000 of type two, 2,000 of type three, 500 type four, etc. Thus, the rarity of the virtual items may be relative to each other. Also, within each item type, there may be varieties of that particular item type. For example, of the 6,000 virtual items of type one, 4,000 may be of variety one, 1,000 may be of variety two, 500 may be of variety three, 300 may be of variety four, and 200 may be of variety five, totaling the 6,000 virtual items of type one. Thus, the rarity of the variety of an item type may be relative to the number of varieties for a given item type. Having different types of virtual items and different varieties of item types may enhance the element of risk and interest in the promotion.

If the customer has another Item Code 202 to redeem, the customer can click on Button Bar 508, which will cause the server computer to return Item Code Web Page 300 for display on the monitor of the customer's computer. If the customer does not have another Item Code 202 to redeem, the customer can click on Button Bar 510, which will cause the server computer to return Home Web Page 600 for display on the monitor of the customer's computer. Or, the user may use Navigation Menu 602 to access other web pages of web site. From Home Web Page 600 or other web pages available from the web site the customer can then manipulate Virtual Item 502 within the context of the web site.

Referring now to FIG. 6, Home Web Page 600 is the home web page for the web site associated with the retail store or the manufacturer and the promotion. Navigation Menu 602 provides links that may be clicked on by the customer, also referred to as the “user”, to access various web pages within the web site. In this example, Web Site 104 is an entertainment web site offering virtual pets. However, one skilled in the art will recognize that other types of web sites would be compatible with the method of the present invention, and the virtual item may have quite varied and diverse functions. There are enumerable combinations of merchants, manufactures, and affiliated or unaffiliated web sites that could develop a successful promotion to enhance merchandise sales, store traffic, and web site traffic utilizing the method of the present invention.

As with other entertainment oriented web sites, virtual items can be manipulated within the bounds of the web site environment. For example, virtual items may be auctioned, traded, or donated to other users of the web site. Virtual items may also be stored, displayed, or discarded by the user. In this context, the virtual item has no real world value, and cannot be bought or sold for real cash in an environment outside the web site, such as on eBay. The terms and conditions of the web site typically set forth these parameters, and users are bound by these terms and conditions.

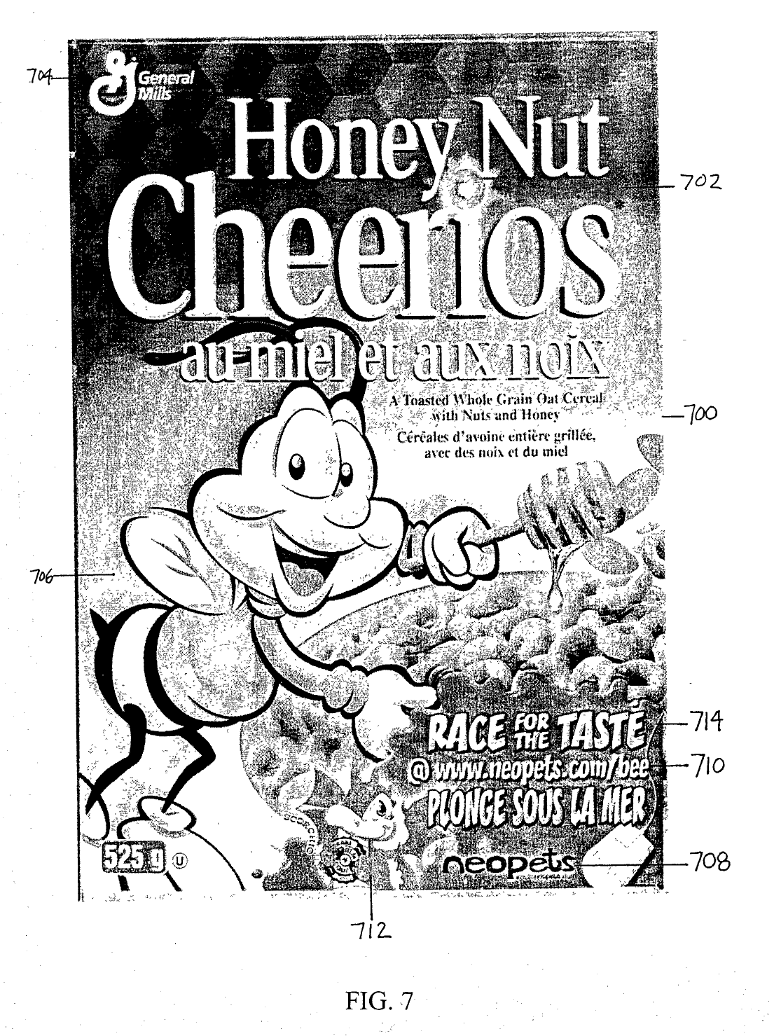

FIG. 7 shows an outer front side of a product package containing a product made available to a customer at a retail store in an embodiment of the present invention. Referring now to FIG. 7, the promotion in this example is between the web site and the product manufacturer who utilizes various retail outlets for distribution of the manufacturer's product or service. Package Front Side 700 is the front of a cereal box containing cereal, having Product Name 702, Manufacturer Name 704, and Product Graphic 706. A graphic for Web Site 708 is shown, along with Game URL 710. Character Graphic 712 indicates that an item code for a virtual item is contained within the cereal box. In this promotion, the web site, in partnership with the manufacturer, has developed a Web-Based Game 714 titled “Race For The Taste.” The character(s) associated with the manufacturer's product (the Honey Nut Cheerios Bee in Product Graphic 706) are incorporated with the character(s) associated with the web site (e.g., the winged dragon labeled “Scorchio” in Character Graphic 712) in the Web-Based Game 714.

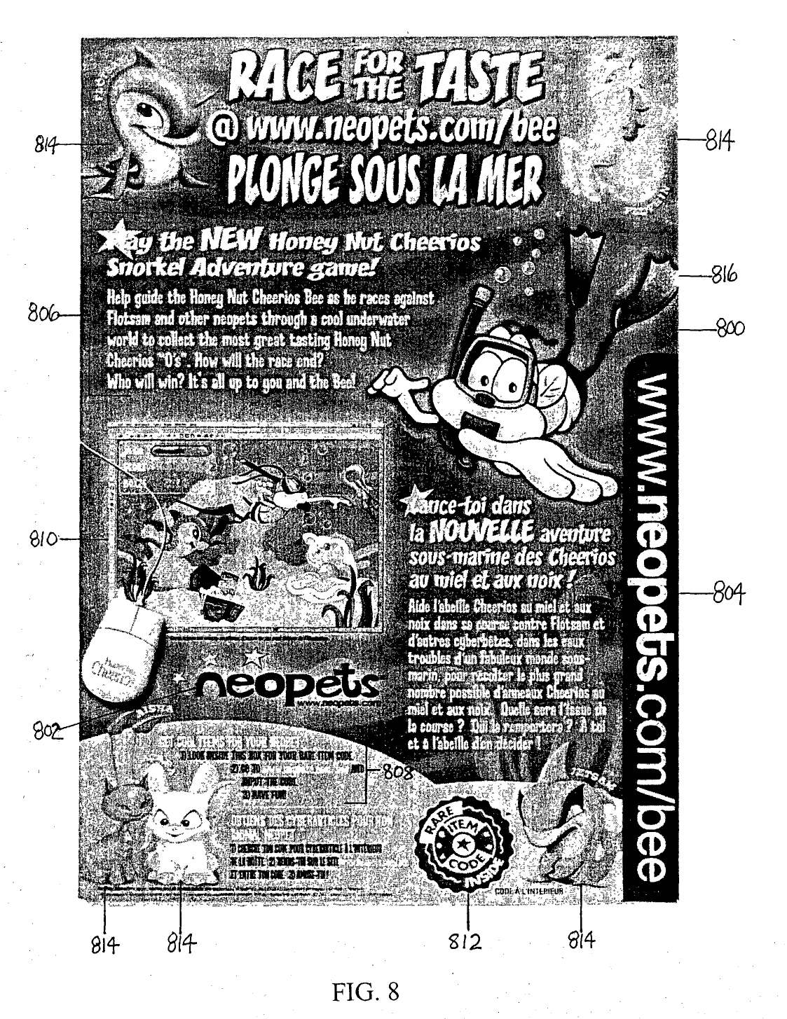

FIG. 8 shows an outer back side of the product package of FIG. 7 made available to a customer at a retail store in an embodiment of the present invention. Referring now to FIG. 8, Package Back Side 800 is the back of the cereal box having a graphic for Web Site 802 along with Game URL 804. Game Description 806, Instructions 808, and Game Graphic 810 provide the customer with information about the promotion. Item Code Inside Graphic 812 indicates that an item code for a virtual item is contained within the cereal box. Several Character Graphics 814 for the web site are shown, as well as Product Graphic 816.

Joint promotions between the web site sponsor and the manufacturer or retail store may be regionally based within a defined geographic or market area (such as a city, standard metropolitan statistical area, state, or country). In the example shown in FIG. 7 and FIG. 8, the promotion is based in Canada, with text shown in both English and French on Package Front Side 700 and Package Back Side 800. Only customers in Canada who are also registered as Canadian users of the web site can participate.

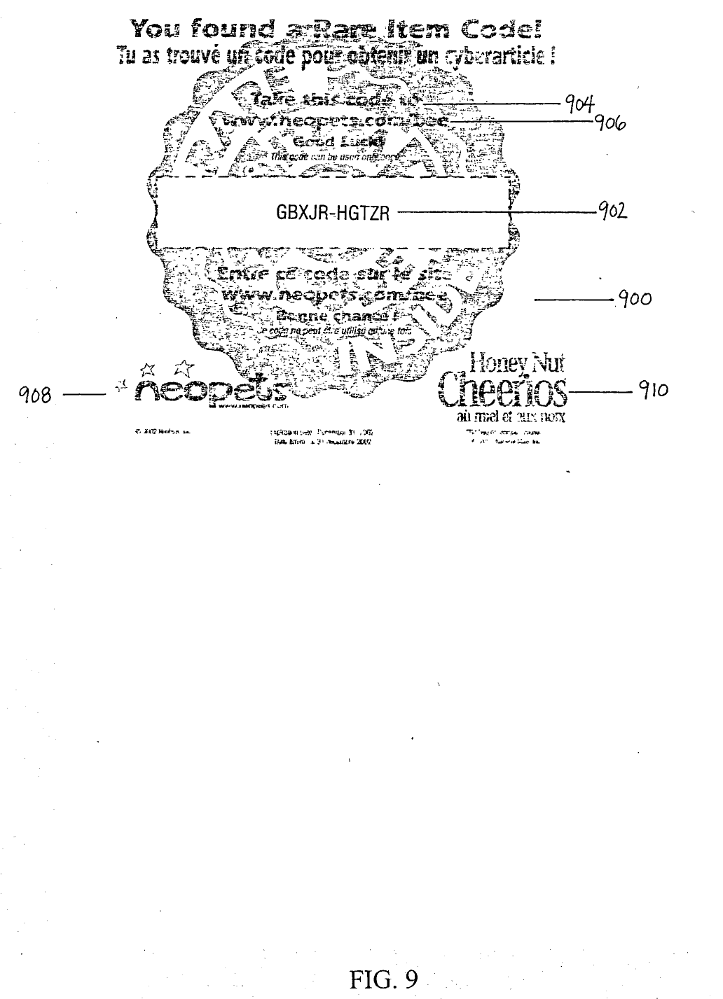

FIG. 9 shows an interior side of the product package of FIG. 7 or FIG. 8. Referring now to FIG. 9, Package Interior Side 900 may be located on the back side of Package Front Side 700, on the back side of Package Back Side 800, or on any other suitable interior side of the package. Thus, the customer must buy the packaged product in order to have the right to open the package and appropriate Item Code 902. Item Code 902 may be a series of numbers, letters, symbols, etc., or any combination of the above. Instructions 904 instruct the customer to use the Item Code 902 at a web site whose address is indicated by Game URL 906. Package Interior Side 900 may have other printed instructions and graphics, such as Web Site 908 and Product Name 910 to provide the customer with other useful information.

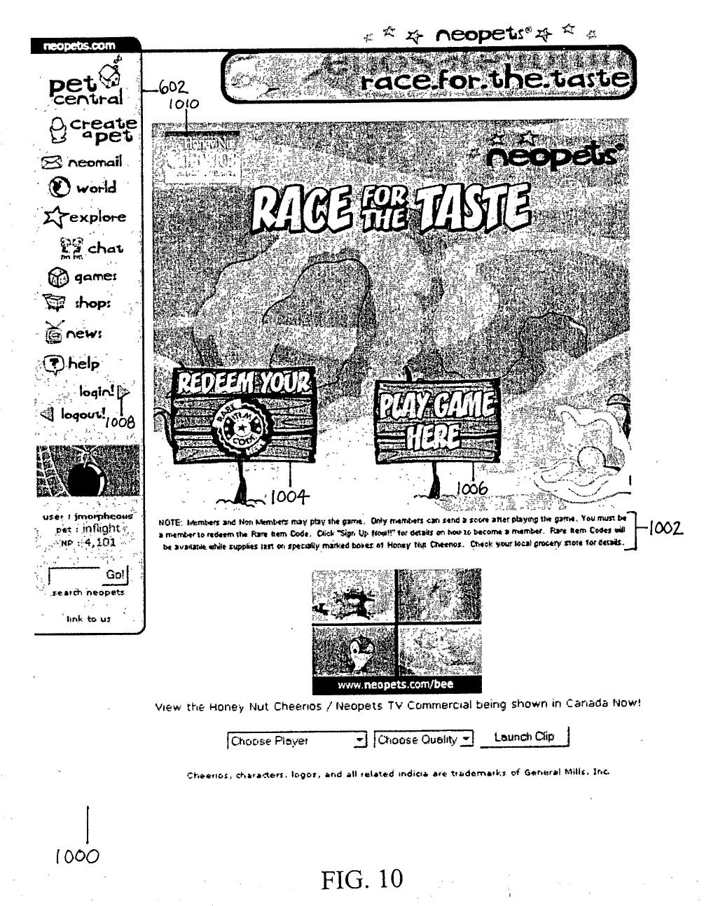

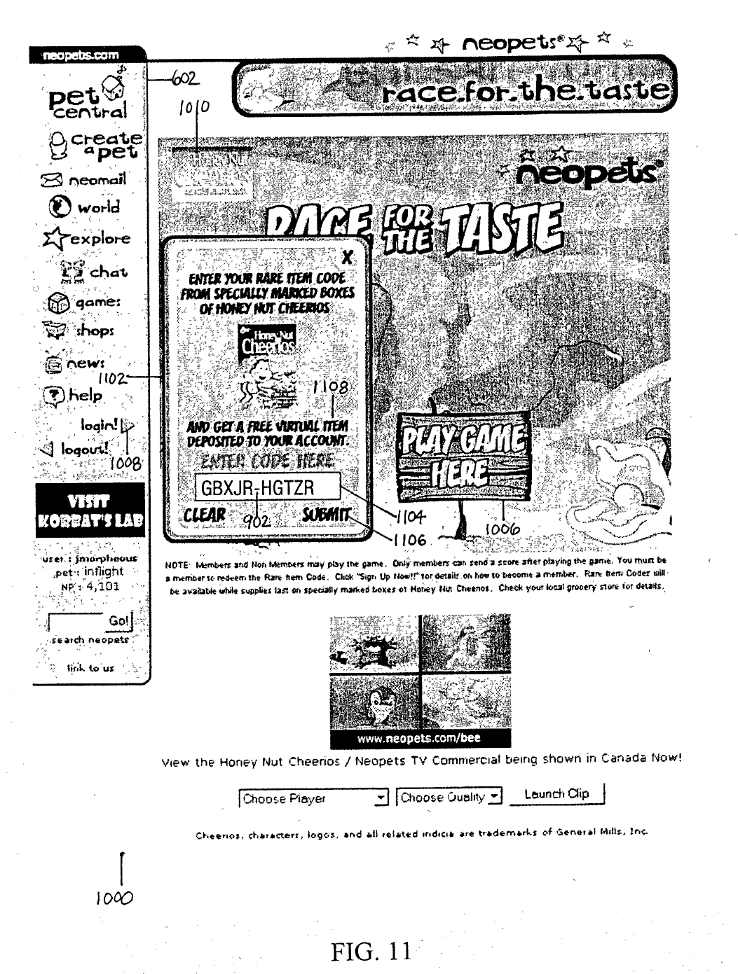

FIGS. 10-11 show representations of exemplary screen shots of web pages delivered by a server computer that may be displayed through a web browser on a display device of a customer computer in an embodiment of the present invention. (The Windows top tool bar, bottom status bar, and right scroll bar, and the web browser address bar are not shown for simplicity.) Referring now to FIG. 10, the customer that has purchased the packaged product described in FIGS. 7, 8, and 9 having Item Code 902, Instructions 904, and Game URL 906, has entered Game URL 906 through a web browser displayed on a monitor of the customer's computer. Web-Based Game Page 1000 is returned to the customer's computer and displayed on the monitor by a server computer associated with Game URL 906 and Web Site 708. Registered users of Web Site 708 may have already logged in to Web Site 708 prior to this point from the Home Web Page 600 (FIG. 6). If not, the user can log in from Web-Based Game Page 1000 by clicking on Login Button 1008 and following the login procedure for Web Site 708. In one embodiment of the invention, non-registered users can play the game, but only registered users can redeem Item Code 902 for a virtual item as explained in Instructions 1002.

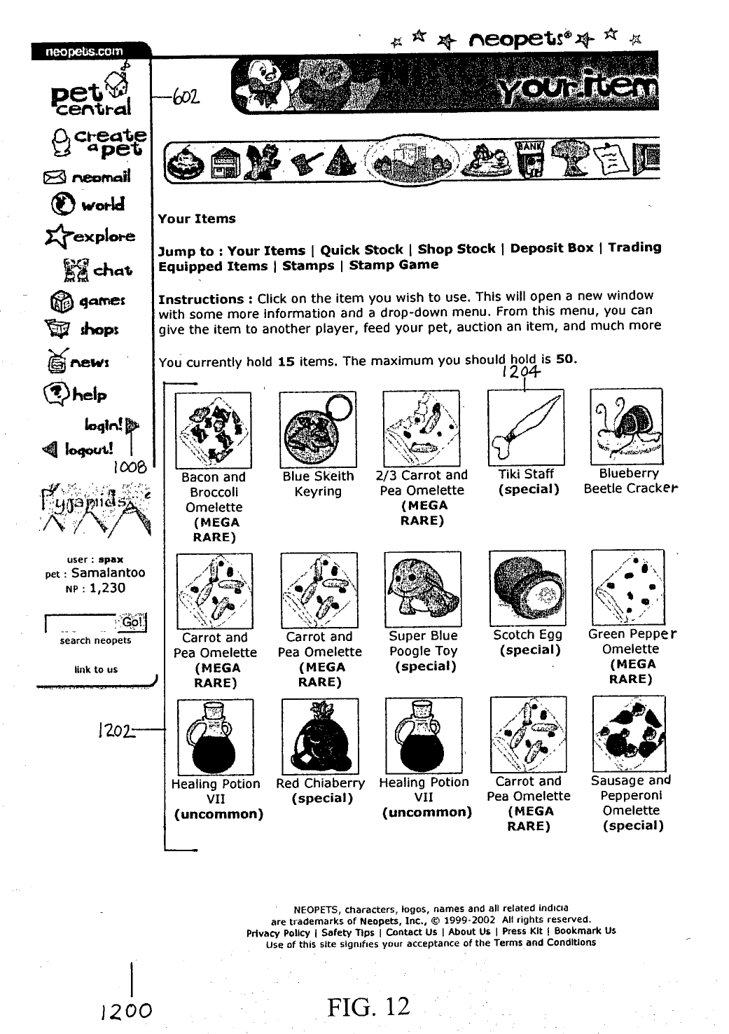

Product Name 1010 is displayed on Web-Based Game Page 1000. Clicking on Redeem Your Rare Item Code Here Graphic 1004 will open up Dialog Box 1102 shown in FIG. 11. Entry Box 1104 is provided for the customer to enter Item Code 902, which the customer has done as shown in FIG. 11. When the customer clicks on Submit 1106, the virtual item is deposited into the customer's account, as explained in Instructions 1108. To view the virtual item acquired, the customer can navigate to Your Items Web Page 1200 (FIG. 12) by utilizing Navigation Menu 602. The customer can click on Play Game Here Graphic 1006 which will open up a new window in which the web-based game will load, enabling the customer to play the game (not shown).

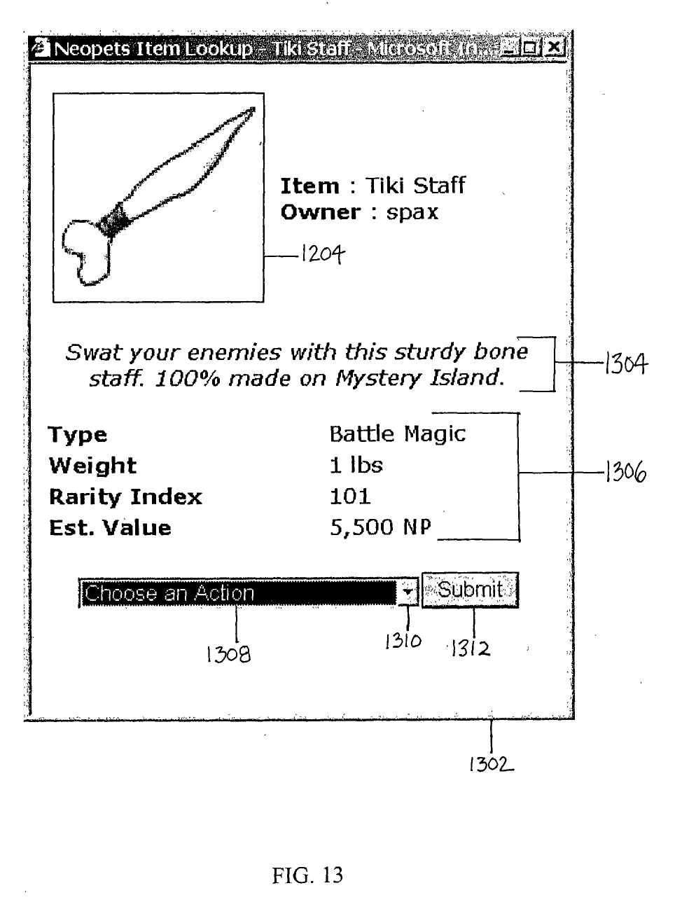

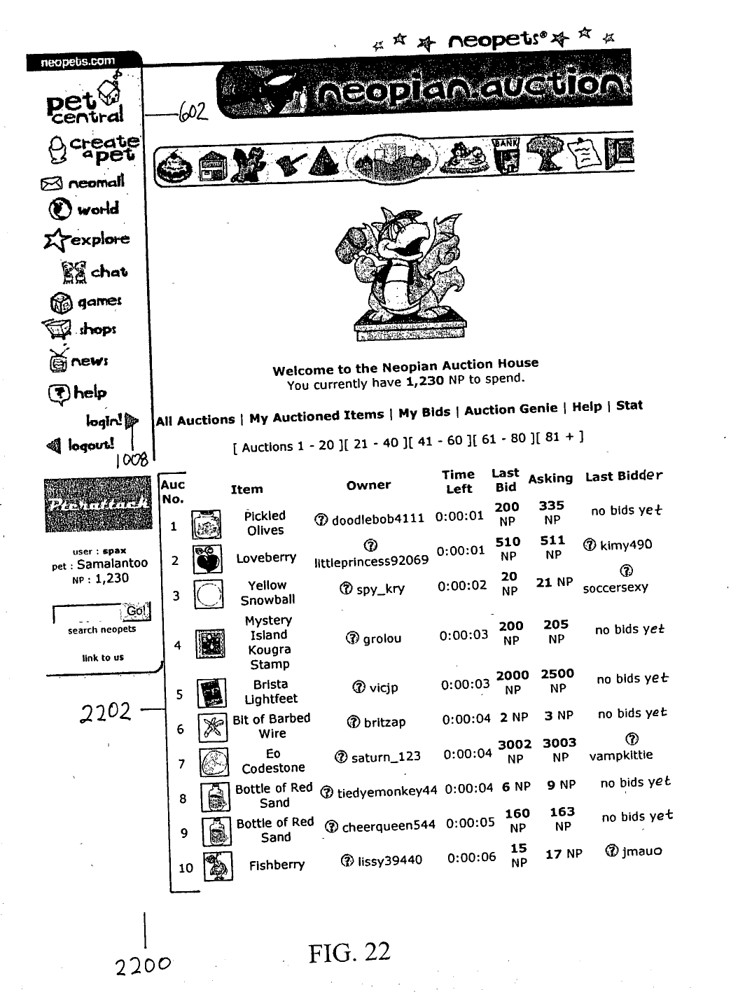

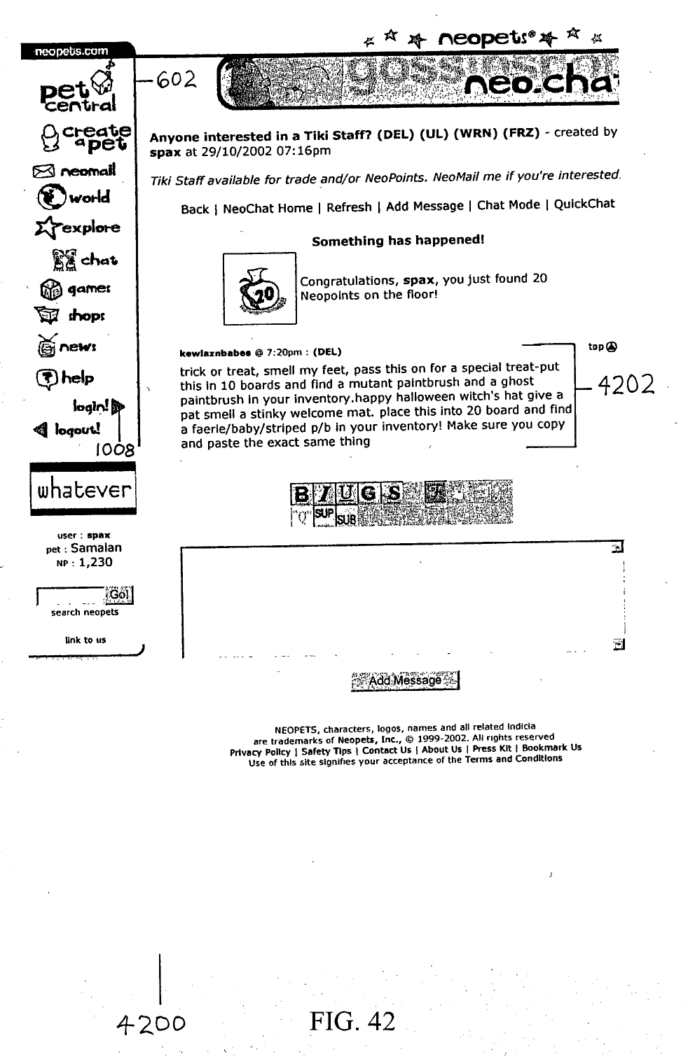

FIGS. 12-42 show representations of exemplary screen shots of web pages delivered by a server computer that may be displayed through a web browser on a display device of a customer computer in an embodiment of the present invention. (The Windows top tool bar, bottom status bar, and right scroll bar, and the web browser address bar are not shown for simplicity.) Referring now to FIG. 12, Your Items Web Page 1200 shows the various Virtual Items 1202 held by the registered user within the context of the entertainment web site. There are many things that a registered user can do with Virtual Items 5 1202 as part of the entertainment web site. Clicking on an individual Virtual Items 1202, such as Tiki Staff 1204, will cause Pop Up Box 1302 (FIG. 13) to be displayed. Pop Up Box 1302 contains Information 1304 about what can be done with the virtual item, in this case, Tiki Staff 1204, and Characteristics 1306 of the virtual item.

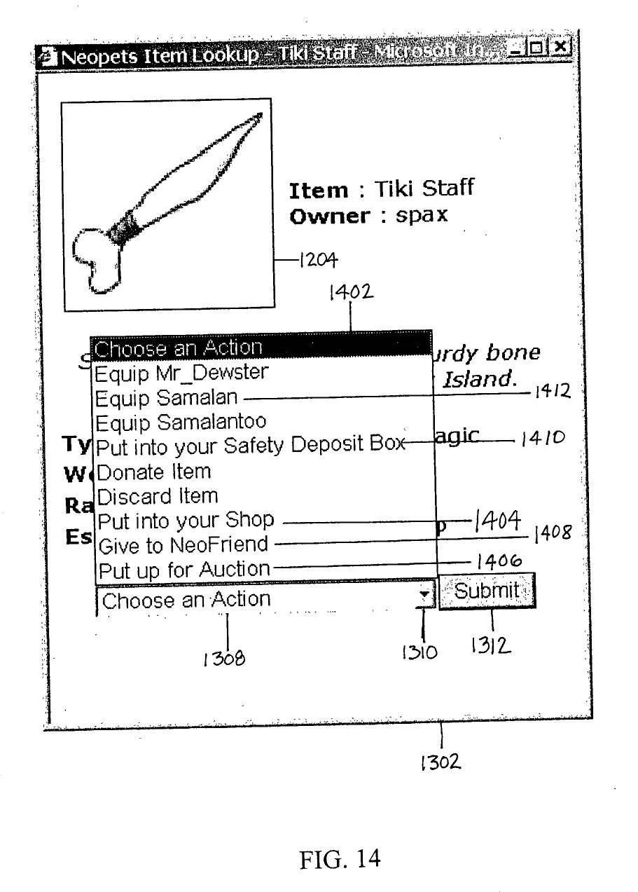

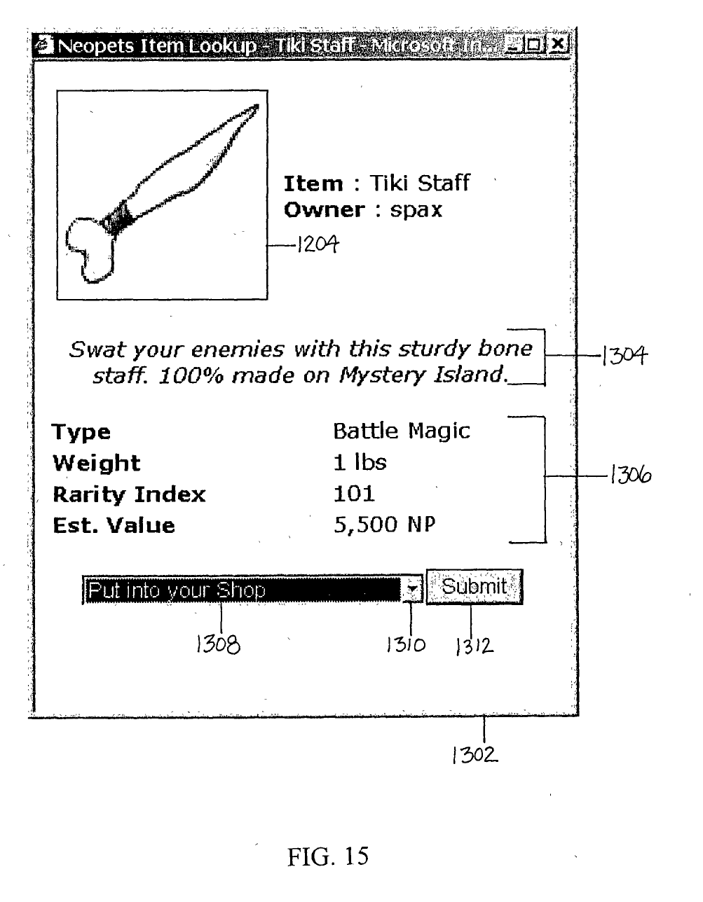

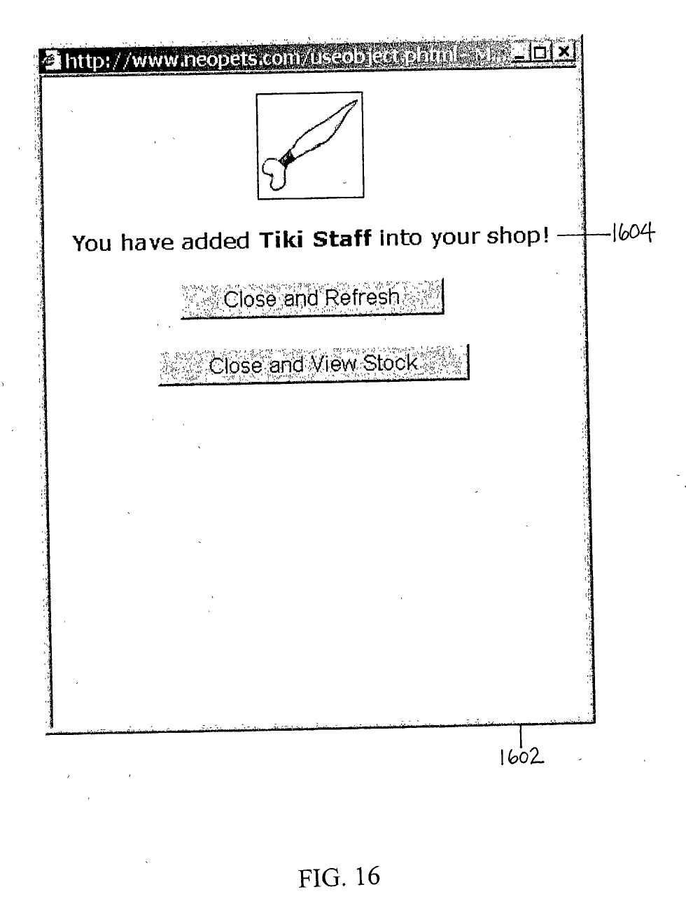

Clicking by the user on Down Arrow 1310 of Choose An Action Box 1308 will cause Pop Up Menu 1402 (FIG. 14) to be displayed within Pop Up Box 1302. Pop Up Menu 1402 contains a list of possible actions the user may select. One of the things the user can do with their Virtual Items 1202 is to put them up for sale in the user's virtual items shop. Clicking by the user on Put Into Your Shop 1404 collapses Pop Up Menu 1402 as shown in FIG. 15. Clicking by the user on Submit Button 1312 causes Pop Up Box 1602 (FIG. 16) to be displayed, which indicates in Message 1604 that Tiki Staff 1204 has been transferred out of the user's account and to the user's virtual items shop.

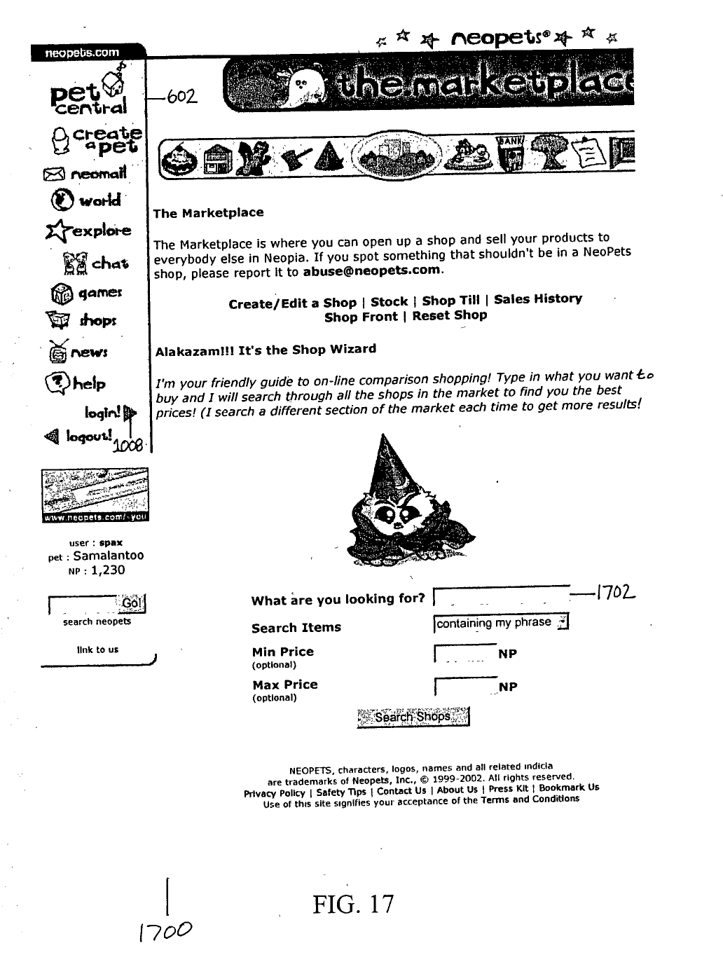

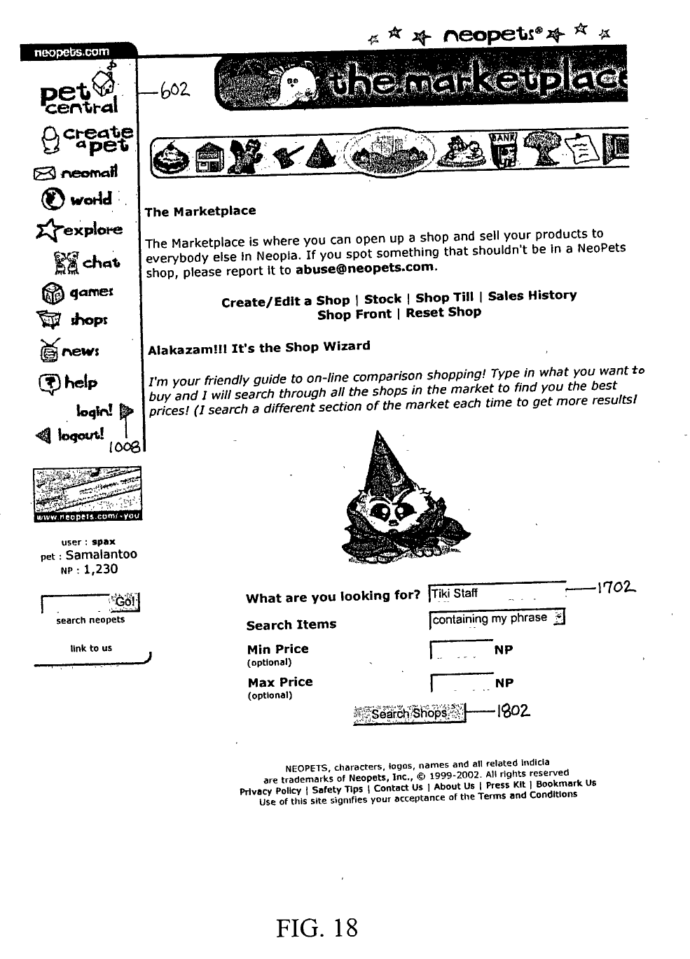

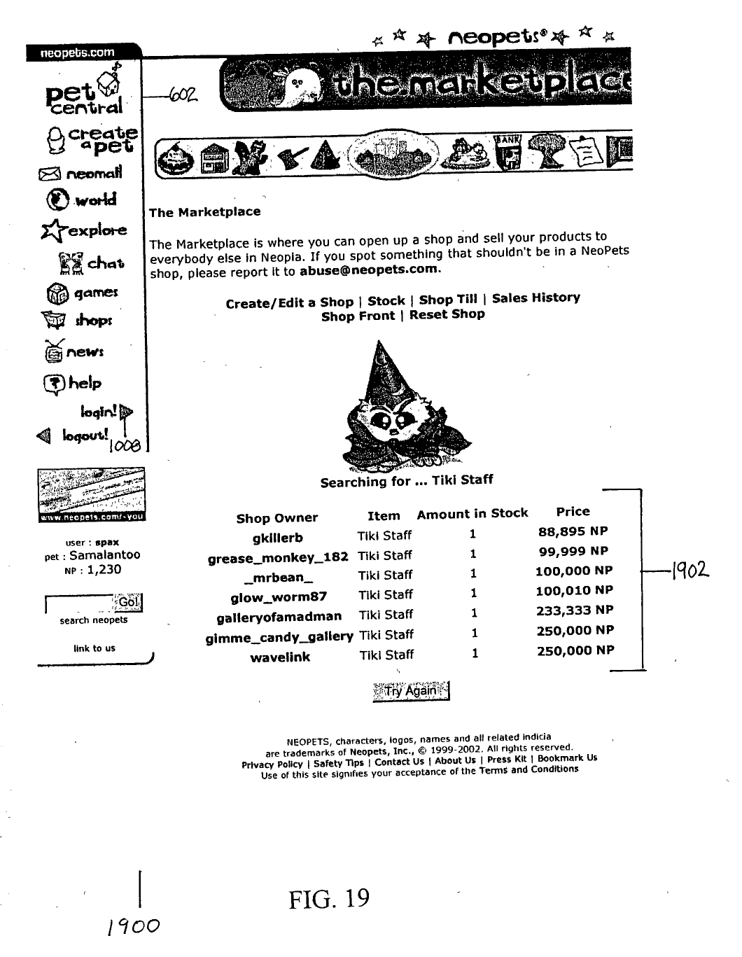

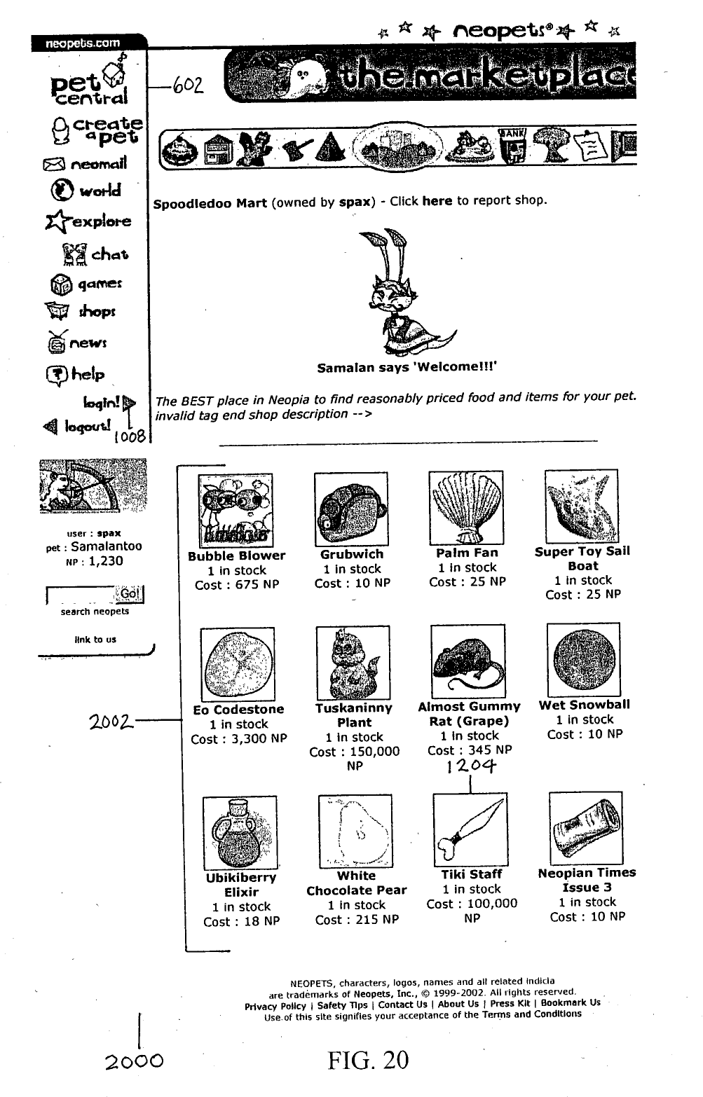

In order to correctly price virtual item Tiki Staff 1204 for sale, within the context of the virtual economy within the web site and the virtual currency used within the web site, the user can check to see what other users of the web site are charging for the same item. Using Navigation Menu 602 Marketplace Web Page 1700 (FIG. 17) is displayed on the monitor of the user's computer. Entry Box 1702 allows the user to type in the name of the virtual item of interest as shown in FIG. 18. Pressing the enter key on a keyboard while the pointer is within Entry Box 1702, or clicking on Search Shops Button 1802, displays Marketplace Search Results Web Page 1900 (FIG. 19). Price List 1902 shows the results of the search, indicating the different prices being asked for by other users for a Tiki Staff. One of the many different aspects of the entertainment web site is to earn as many virtual currency points as possible. Thus, a rare item such as Tiki Staff 1204 can be very valuable and important to game play for the user. Armed with this information, the user can then choose a price for Tiki Staff 1204 for resale purposes in the user's shop. User Shop Web Page 2000 (FIG. 20) shows Tiki Staff 1204 is now one of the Sale Items 2002 in the user's shop with an asking price of 100,000 virtual points.

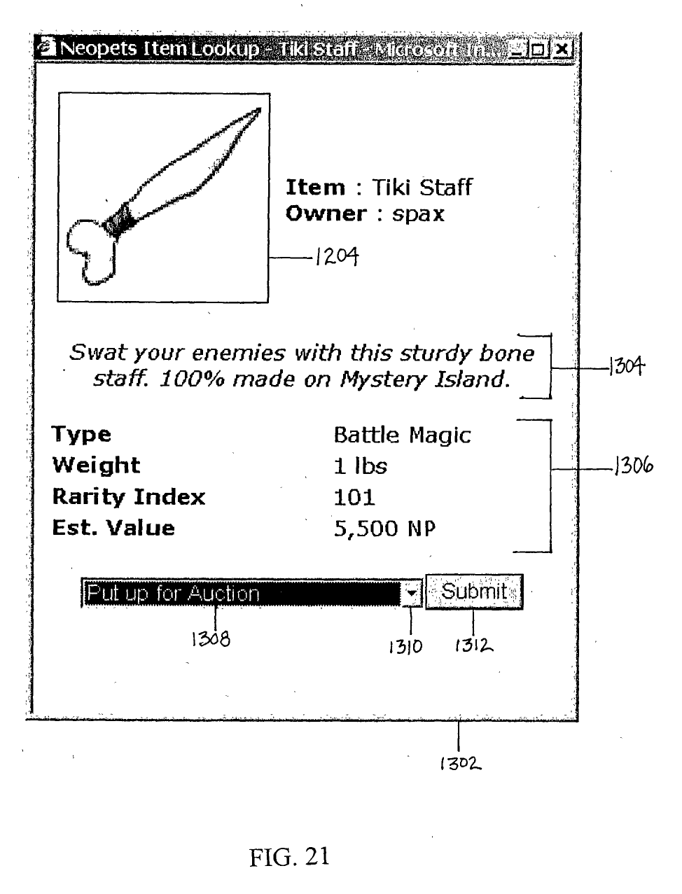

Referring again to FIG. 14, clicking by the user on Put Up For Auction 1406 collapses Pop Up Menu 1402 as shown in FIG. 21. Clicking by the user on Submit Button 1312 causes Auctions Web Page 2200 to be displayed. Only the first ten items in Auction Items 2202 are displayed. By scrolling down the screen Tiki Staff 1204 would eventually be visible at the end of the list of Auction Items 2202 (not shown). Other users can now bid on Tiki Staff 1204 using the virtual currency similar to real world auction sites such as eBay.com.

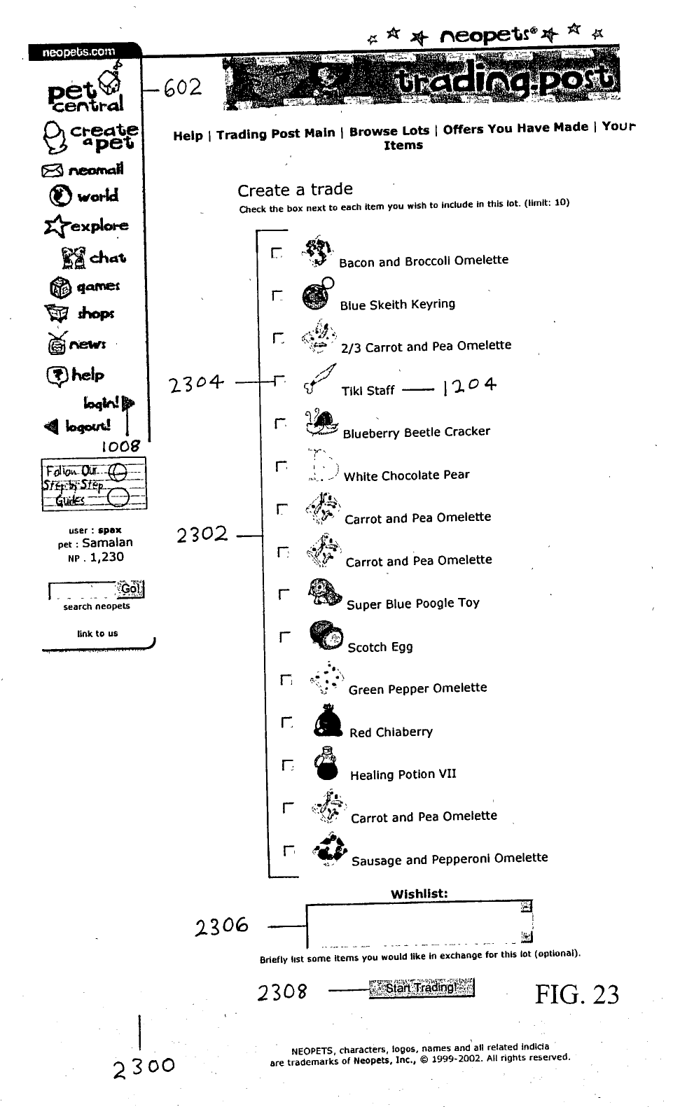

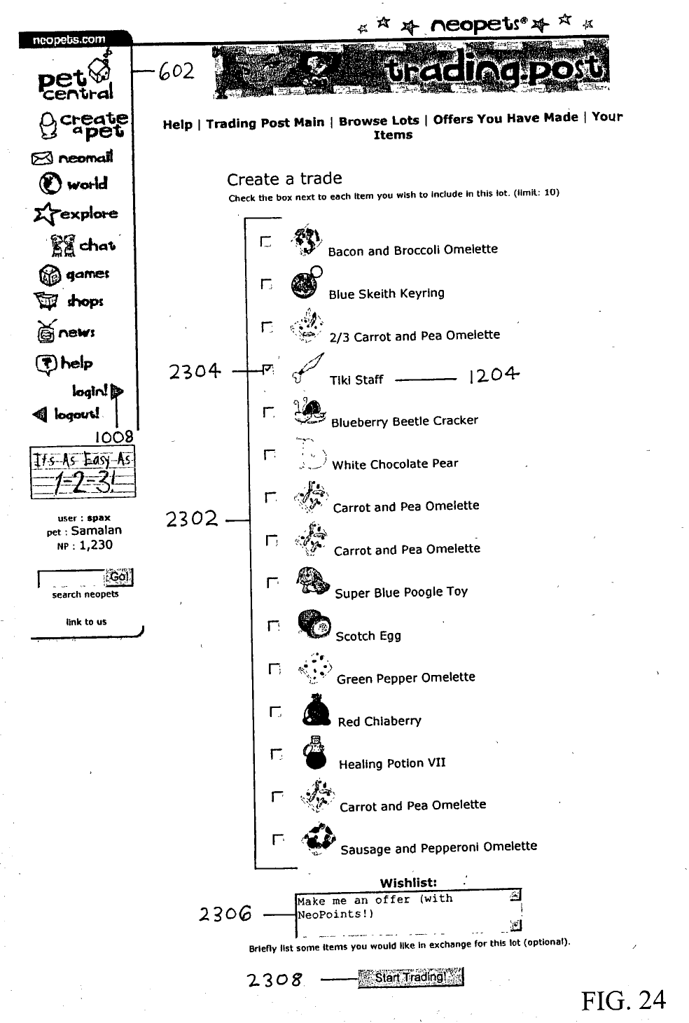

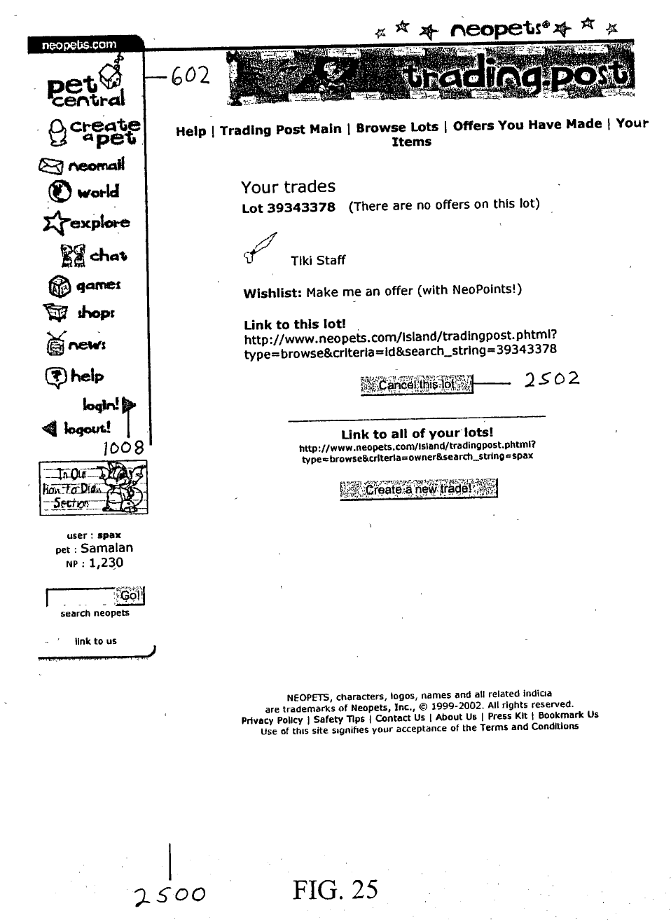

Another action the user can take with a virtual item such as Tiki Staff 1204 is to trade it with another user for another virtual item. Using Navigation Menu 602, Trading Post Web Page 2300 (FIG. 23) may be displayed on the monitor of the user's computer. The user's current Virtual Items 2302 that are available for trade are displayed, including Tiki Staff 1204. By clicking in Check Box 2304, the user can select Tiki Staff 1204 to create a trade as shown in FIG. 24. The user may type in a message in Text Entry Box 2306. Clicking on Start Trading Button 2308 returns Your Trades Web Page 2500 (FIG. 25). From Your Trades Web Page 2500 the user can rescind the trade by clicking on Cancel This Lot Button 2502.

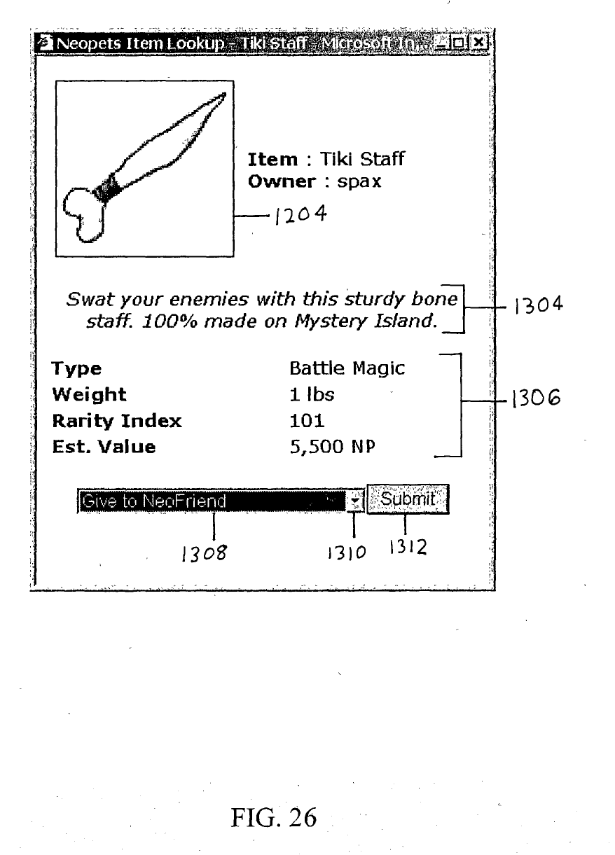

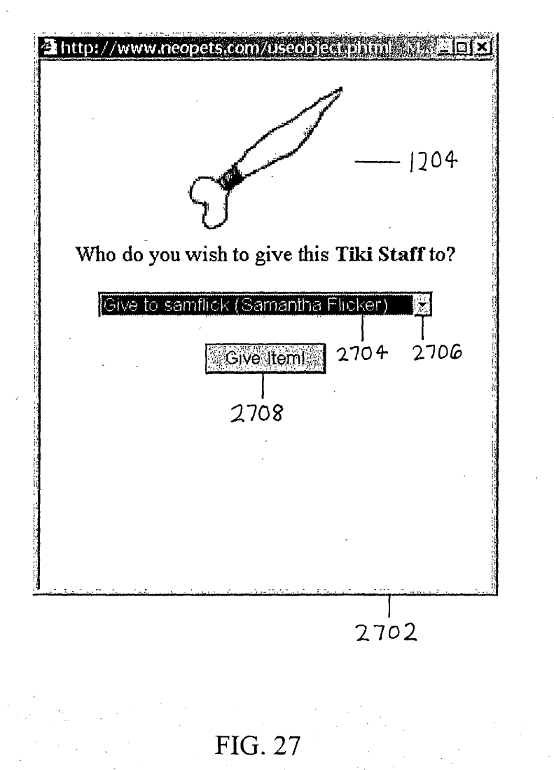

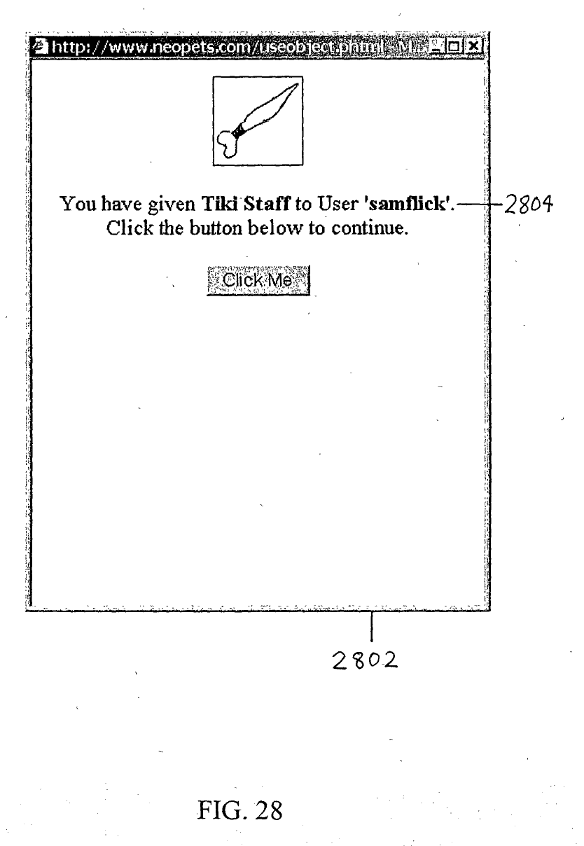

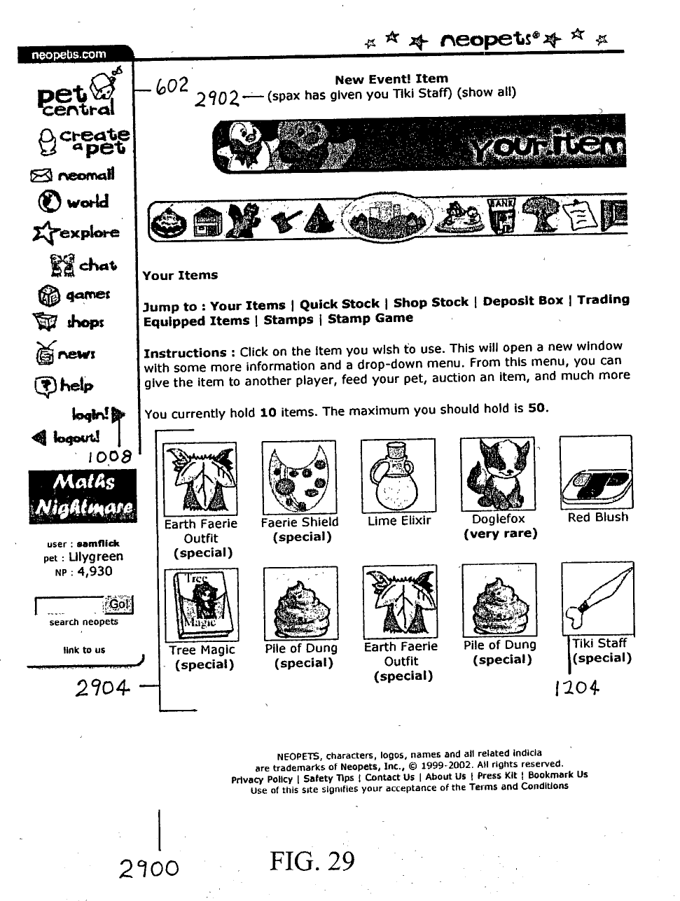

Another action the user can take with a virtual item such as Tiki Staff 1204 is to give it as a gift to another user. Referring again to FIG. 14, clicking by the user on Give To NeoFriend 1408 collapses Pop Up Menu 1402 as shown in FIG. 26. Clicking by the user on Submit Button 1312 causes Pop Up Box 2702 (FIG. 27) to be displayed. Clicking by the user on Down Arrow 2706 will reveal a pop up menu (not shown) listing previously identified fellow web site users known by the user. The user has selected to give Tiki Staff 1204 to the fellow user displayed in Selection Box 2704 (Samantha Flicker) which is now collapsed. Hitting the enter key while the mouse pointer is pointing within Selection Box 2704, or clicking on Give Item Button 2708 will automatically transfer Tiki Staff 1204 from the user's account to the account of the fellow user displayed in Selection Box 2704. Pop Up Box 2802 (FIG. 28) is then displayed, indicating that Tiki Staff 1204 has been given to a fellow user through Message Text 2804. Your Items Web Page 2900 (FIG. 29) will be displayed to the fellow user who received Tiki Staff 1204 as indicated by Message Text 2902. Tiki Staff 1204 is also displayed as one of the virtual items in the fellow user's list of Virtual Items 2904.

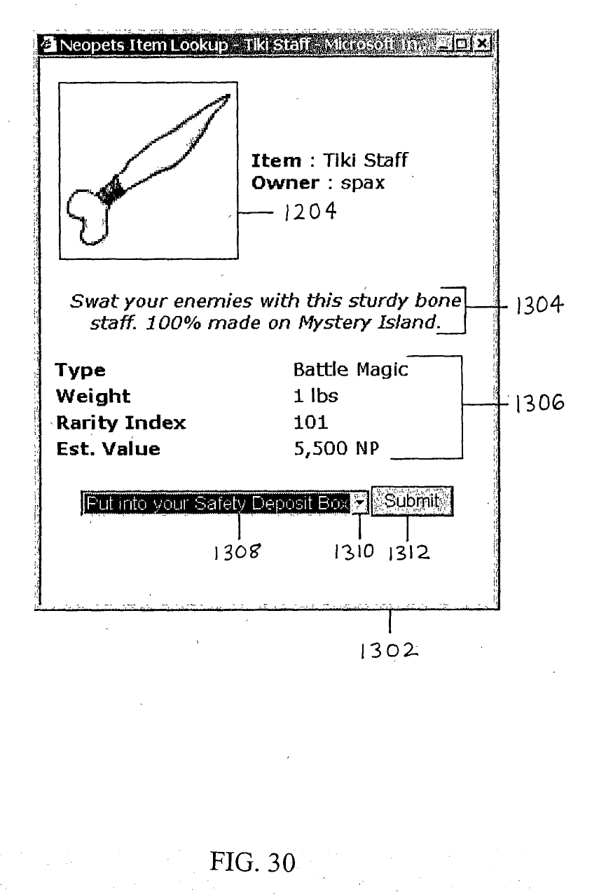

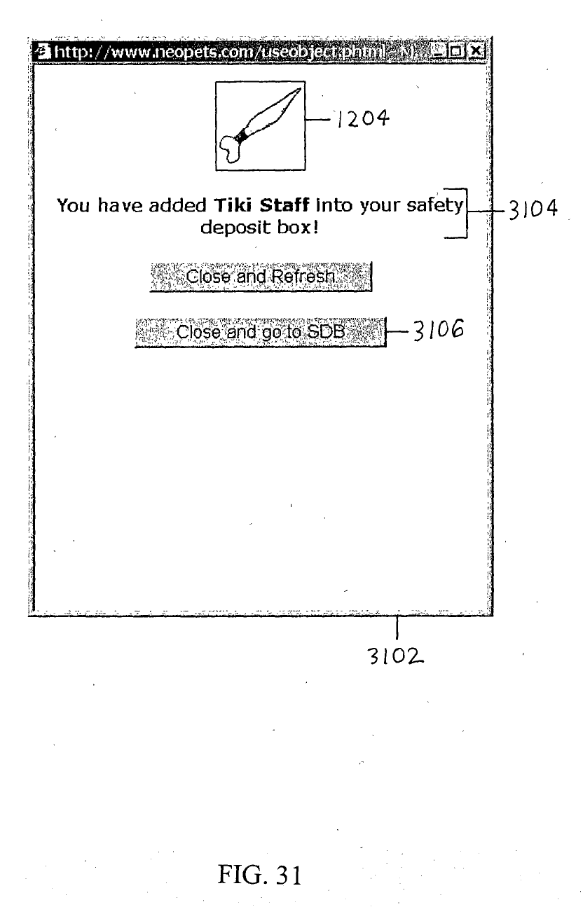

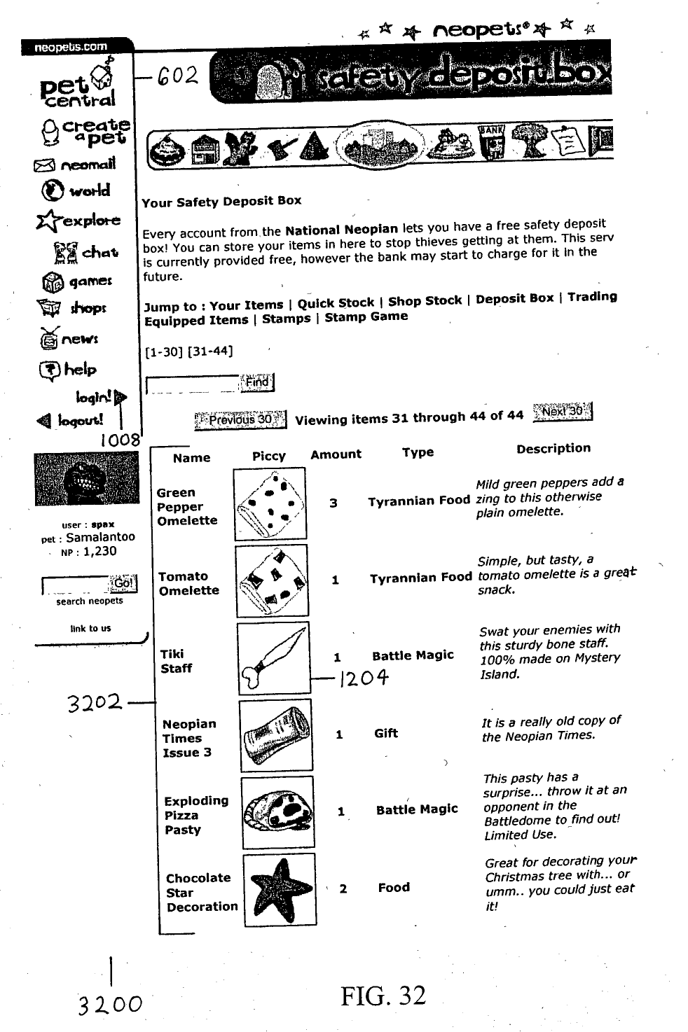

Another action the user can take with a virtual item such as Tiki Staff 1204 is to just keep the virtual item for later use. Referring again to FIG. 14, clicking by the user on Put Into Your Safety Deposit Box 1410 collapses Pop Up Menu 1402 as shown in FIG. 30. Clicking by the user on Submit Button 1312 causes Pop Up Box 3102 (FIG. 31) to be displayed. This automatically transfers Tiki Staff 1204 into the user's safe deposit box area of the user's account for safe keeping until the user decides to take another action with the virtual item. This is indicated by Message Text 3104. Clicking by the user on Close And Go To SDB Button 3106 causes Your Safety Deposit Box Web Page 3200 (FIG. 32) to be displayed. This automatically transfers Tiki Staff 1204 into the user's safety deposit box area of the user's account for safe keeping until the user decides to take another action with the virtual item. Tiki Staff 1204 is now shown among the list of Virtual Items 3202 within the user's safe deposit box area.

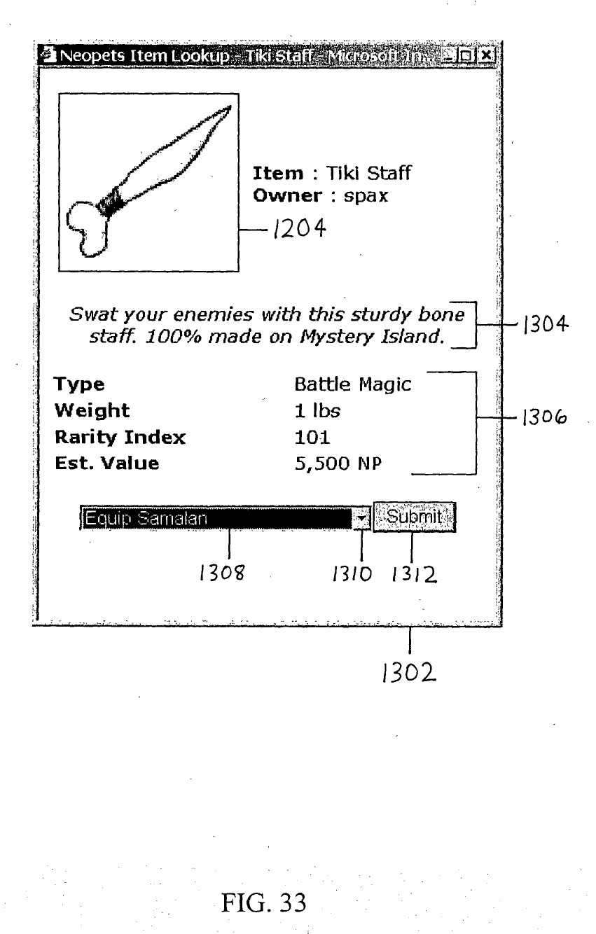

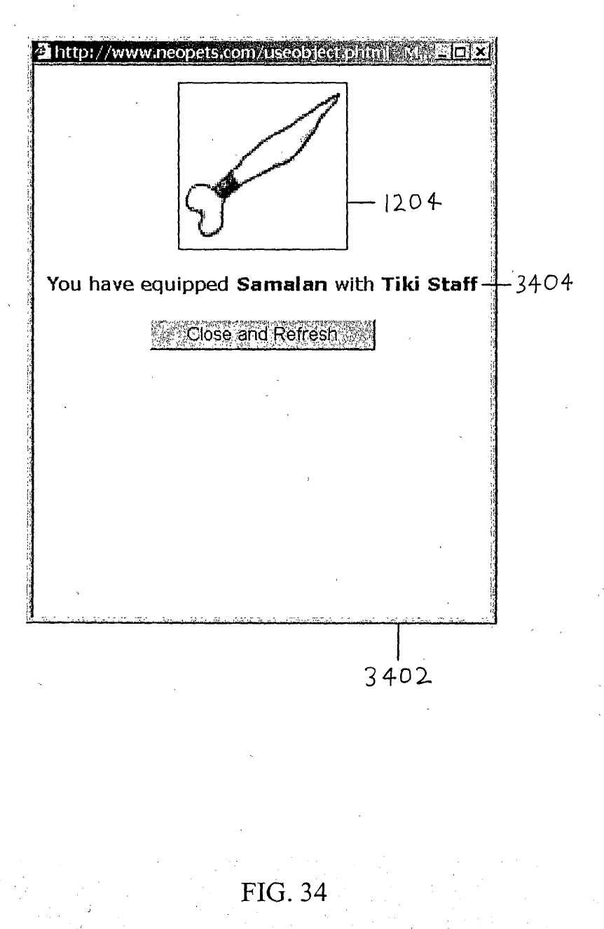

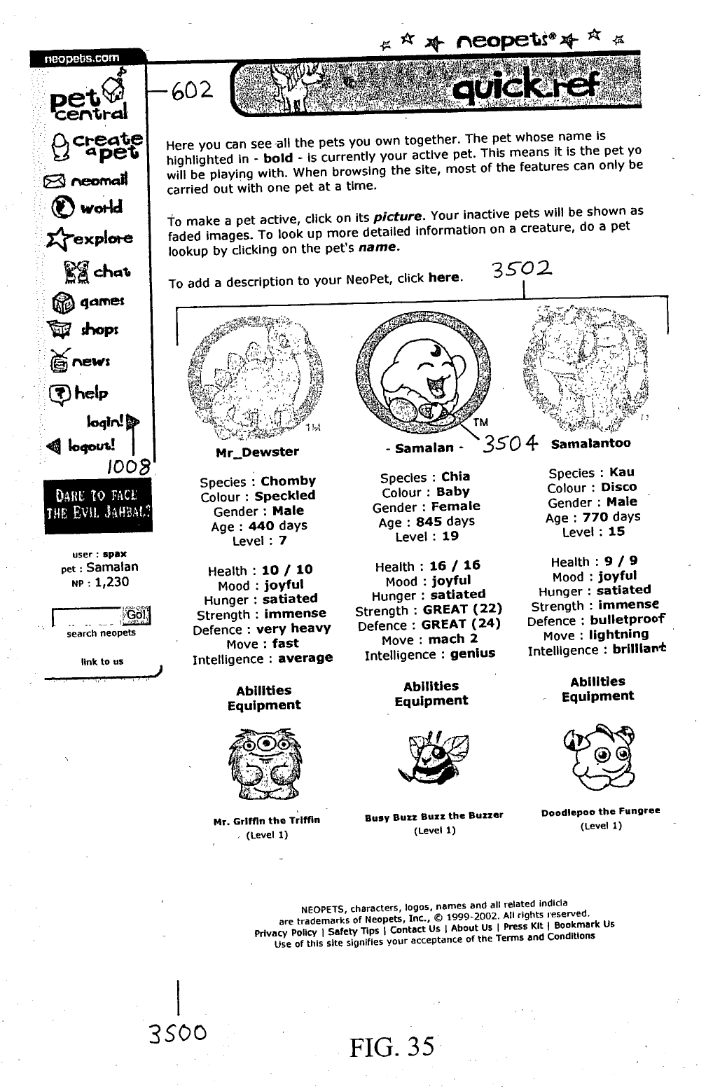

Another action the user can take with a virtual item such as Tiki Staff 1204 is to give the virtual item to one of the user's virtual pets according to the parameters established by the web site. Referring again to FIG. 14, clicking by the user on Equip Samalan 1412 collapses Pop Up Menu 1402 as shown in FIG. 33. Clicking by the user on Submit Button 1312 causes Pop Up Box 3402 (FIG. 34) to be displayed. This automatically equips the virtual pet named “Samalan” with the Tiki Staff 1204. This is indicated by Message Text 3404. Using Navigation Menu 602, Quick Reference Web Page 3500 (FIG. 35) may be displayed on the monitor of the user's computer. All of the user's Virtual Pets 3502 are shown, including Samalan 3504. Again, using Navigation Menu 602, Battledome Game Web Page 3600 (FIG. 36) may be displayed on the monitor of the user's computer. Battledome Game Web Page 3600 is a game within the web site that utilizes the virtual pets, such as Samalan 3504. A list of Virtual Items 3602 that Samalan 3504 is equipped with is shown, including Tiki Staff 1204. Scrolling down the web page will reveal more of the Virtual Items 3602.

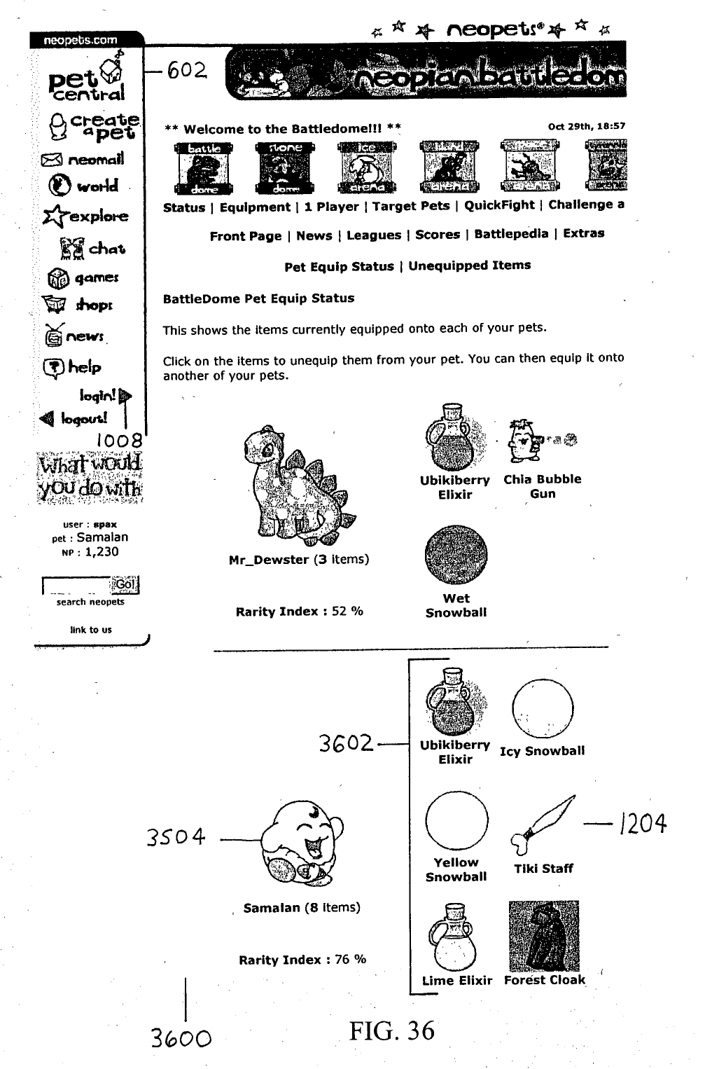

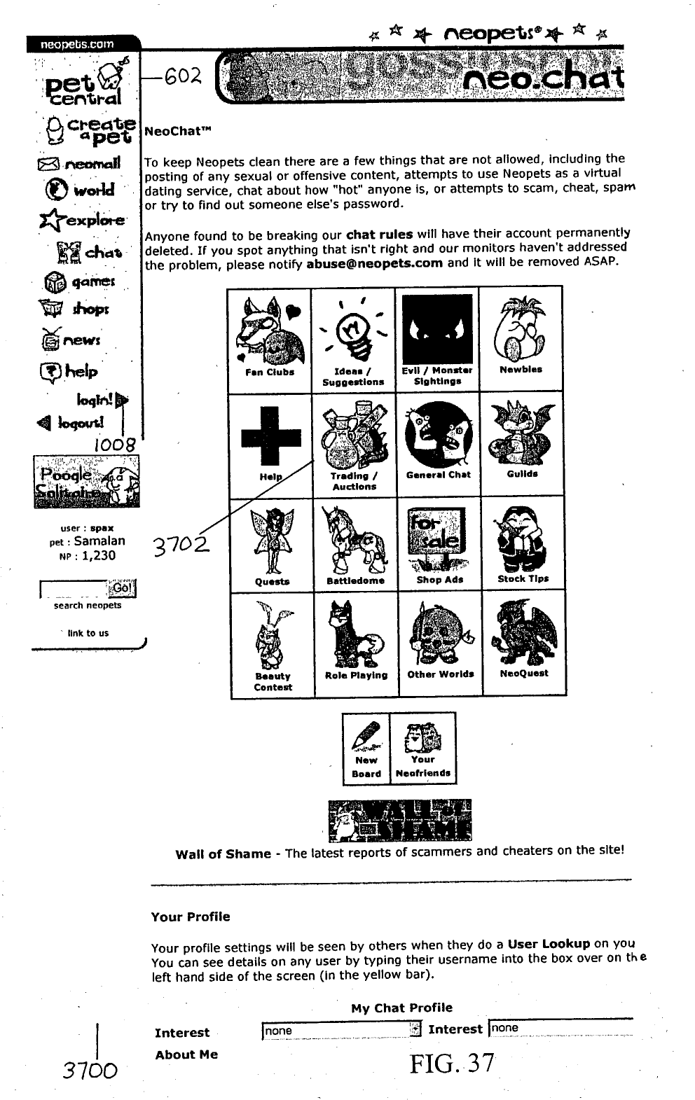

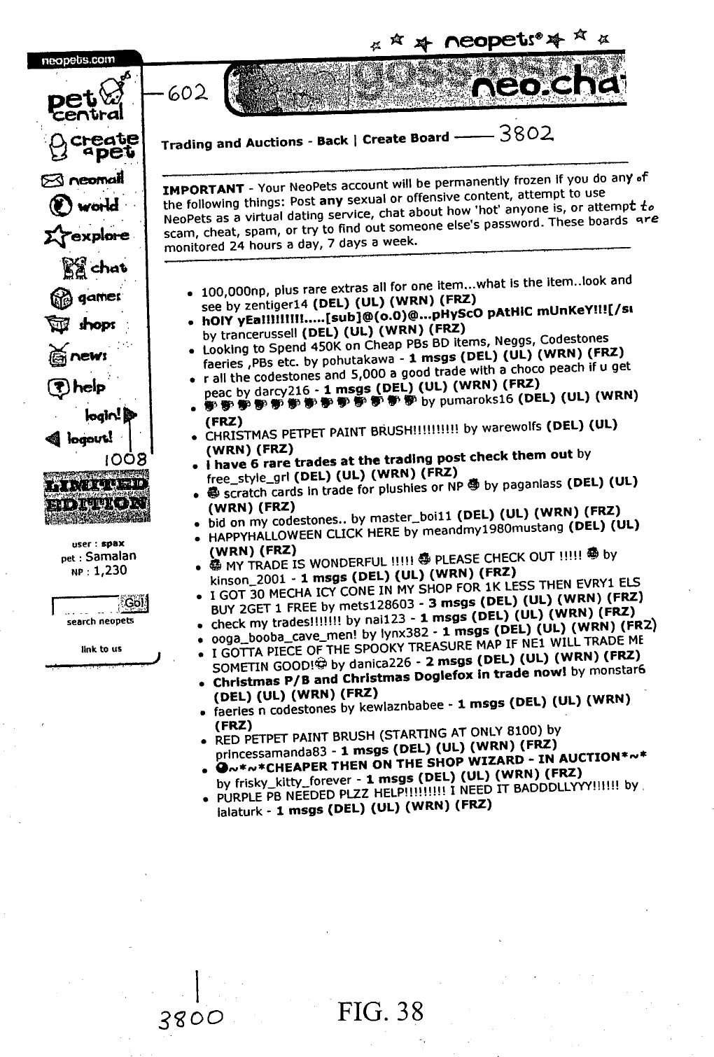

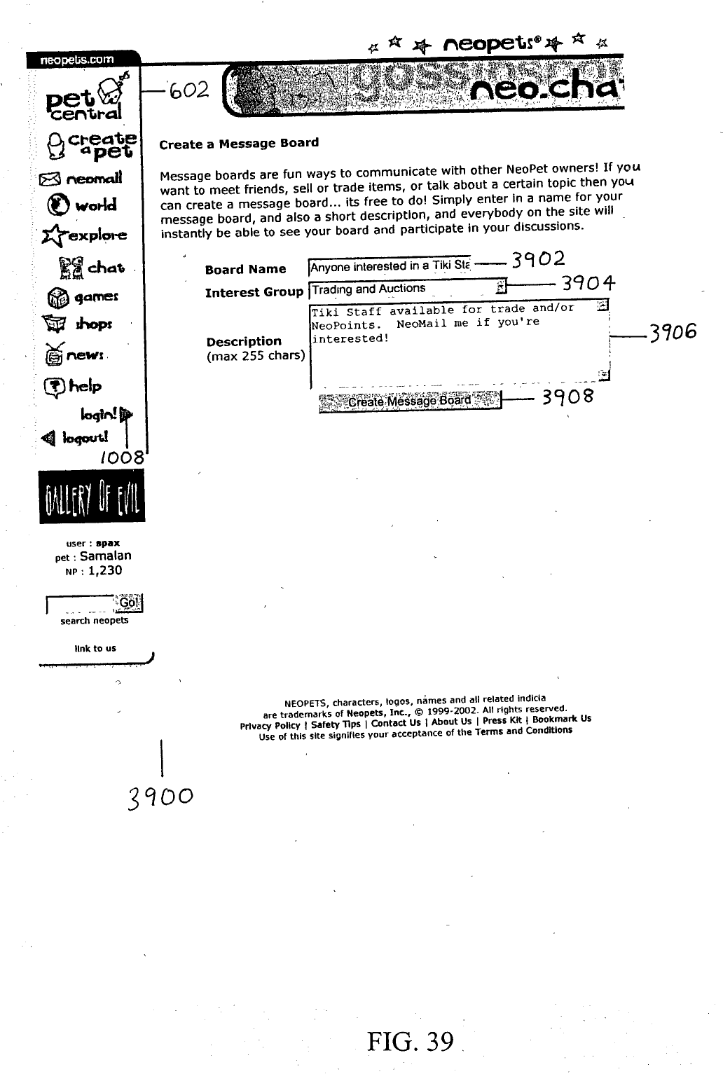

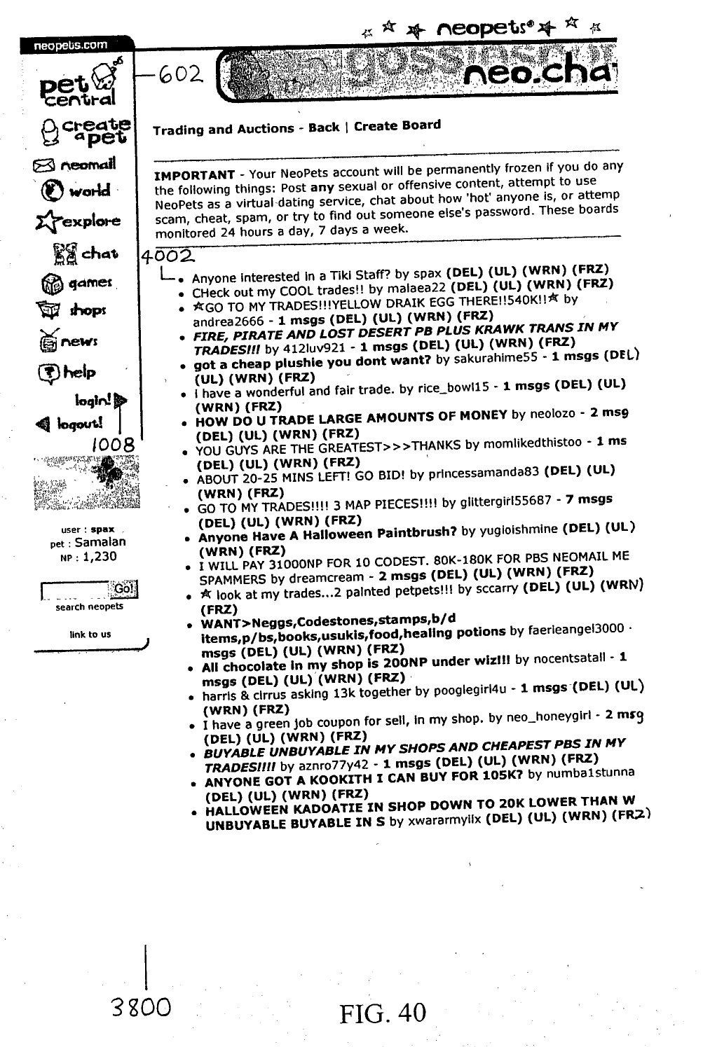

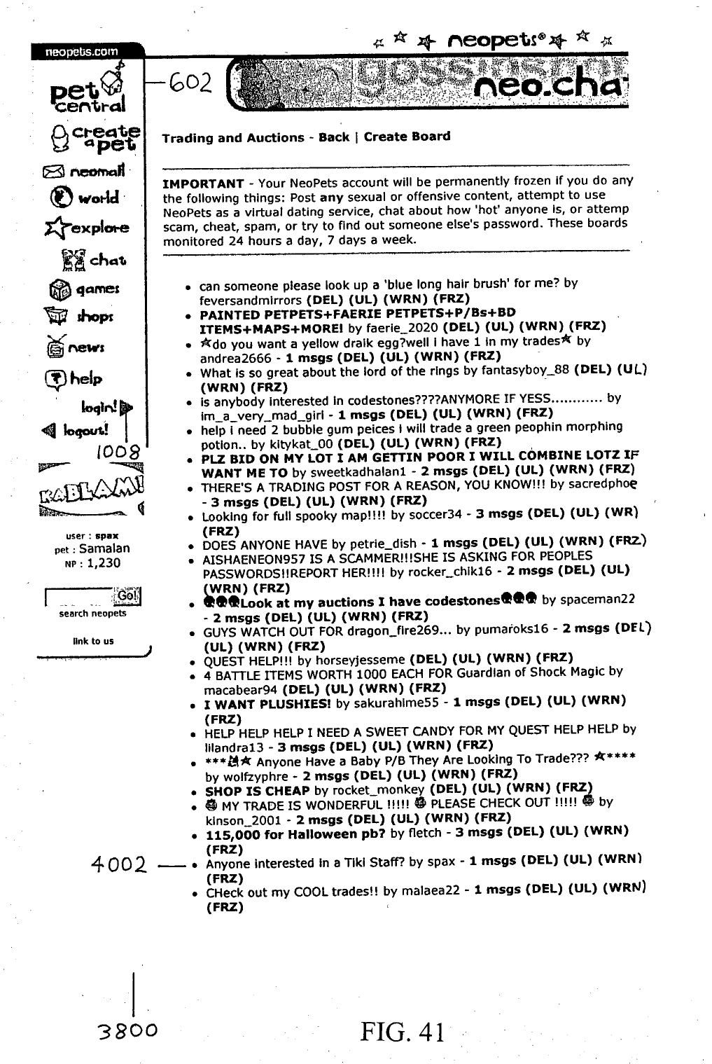

Another action the user can take with a virtual item such as Tiki Staff 1204 is to communicate with other users about the virtual item through a message board within the web site. Using Navigation Menu 602, Chat Web Page 3700 (FIG. 37) may be displayed on the monitor of the user's computer. Clicking by the user on Trading/Auctions Icon 3702 causes Trading And Auctions Web Page 3800 (FIG. 38) to be displayed on the monitor of the user's computer. Clicking by the user on Create Board Link 3802 causes Create A Message Board Web Page 3900 (FIG. 39) to be displayed. Several text entry boxes are provided for the user to enter information, including Board Name Text Entry Box 3902, Interest Group Text Entry Box 3904, and Description Text Entry Box 3906. After the user has typed in the desired information or made selections from pull-down menus as shown in FIG. 39, clicking on Create Message Board Button 3908 by the user automatically posts the message board just created to Trading And Auctions Web Page 3800 (see FIG. 40) as Message Board 4002. Generally, after a period of time, other users will respond to Message Board 4002 as shown in FIG. 41. Trading And Auctions Web Page 3800 has been updated with more message boards, and an indication that one message has been posted in response to Message Board 4002. By clicking on Message Board 4002 as shown in FIG. 41, Chat Message Web Page 4200 is displayed on the monitor of the user's computer. The full text of the response is found in Response Message 4202.

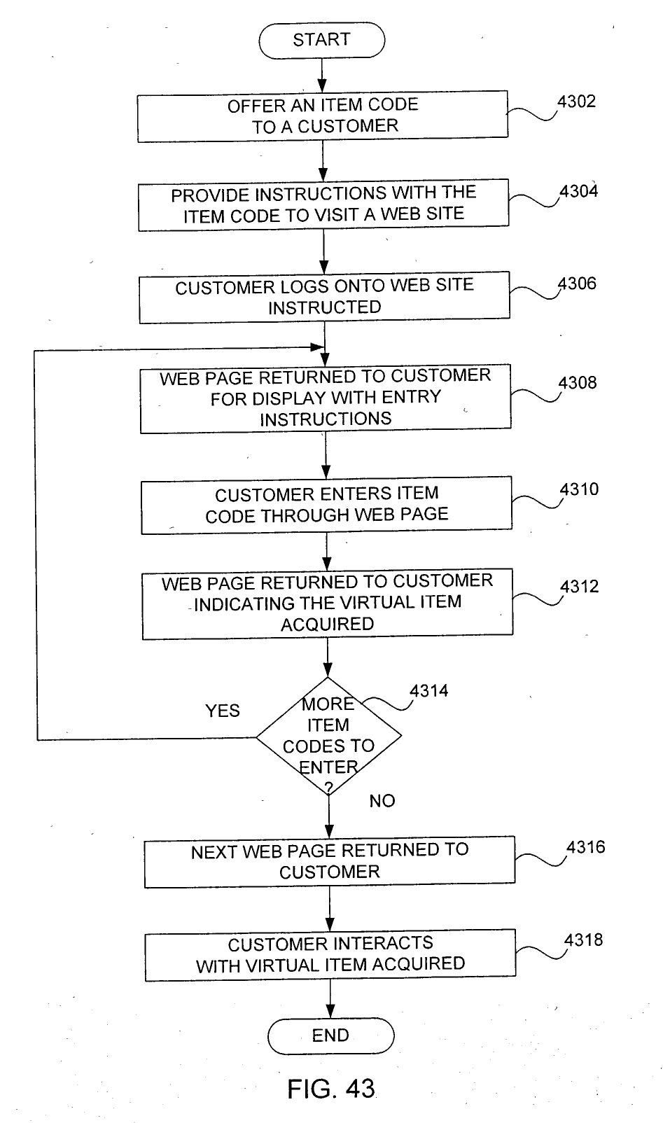

FIG. 43 shows a flow diagram of an embodiment of the method of the present invention. Referring now to FIG. 43, in step 4302 an item code is offered to a customer at a retail store, a place of business, or other promotional site in one of the ways described above. In step 4304 instructions are provided with the item code directing the customer to visit a web site, the instructions including the URL of the web site. In step 4306 the customer, utilizing a computer equipped with a web browser, a connection to the Internet, and a display device, such as a computer monitor, accesses the web site utilizing the URL address.

A server computer associated with the web site in step 4308 returns to the customer's computer a web page for display on the customer's monitor providing instructions to the user regarding the item code. The customer then follows the instructions provided and enters the item code where provided for on the web page and submits the item code in step 4310. In step 4312 the server computer receives the item code, processes the item code, and returns to the customer's computer a web page for display indicating the virtual item that the customer has acquired through the item code. If it is determined in step 4314 that the customer has more item codes to enter, then control returns to step 4308.

If it is determined in step 4314 that the customer does not have more item codes to enter, then in step 4316 the home page of the web site, or some other web page of the web site, is returned to the customer's computer. In step 4318 the customer may now interact within the environment provided for by the web site with the virtual item(s) acquired.

Having described the present invention, it will be understood by those skilled in the art that many changes in construction and widely differing embodiments and applications of the invention will suggest themselves without departing from the scope of the present invention.

What is claimed is:

1. A method for mutually enhancing retail- sales and user traffic on a web site, the method comprising:
(a) offering an item code to a customer, wherein said offer includes an instruction to visit a web site to redeem said item code for a virtual item;
(b) logging onto said web site by said customer wherein said web site is affiliated with said offering of said item code to said customer;
(c) returning a web page to said customer in response to said logging onto said web site, said web page having an entry instruction for said item code;
(d) entering by said customer said item code in said web page on said web site;
(e) returning a virtual item to said customer through said web site; and
(f) utilizing said virtual item by said customer within said web site.
